(19) United States
(12) Patent Application Publication
(10) Pub. No.: US 2026/0106707 A1
(43) Pub. Date: Apr. 16, 2026

(54) ANTENNA SELECTION FOR A MULTIPLE TRANSMITTER WIRELESS DEVICE

(71) Applicant: Apple Inc., Cupertino, CA (US)

(72) Inventors: Lijie ZHANG, Beijing (CN); Hailong YANG, San Francisco, CA (US); Kexin MA, San Diego, CA (US); Lakshmi N. KAVURI, San Jose, CA (US); Zhiwei WANG, Beijing City (CN)

(21) Appl. No.: 19/117,186

(22) PCT Filed: Oct. 14, 2022
(86) PCT No.: PCT/CN2022/125320

§ 371 Date: Mar. 31, 2025

(51) Int. Cl. H04L 5/00; H04B 17/318; H04L 27/26

(52) U.S. Cl. CPC H04L 5/0044; H04B 17/328; H04L 27/261

(57) ABSTRACT

This application describes mechanisms to manage antenna selection for a wireless device. The wireless device transmits sounding reference signal (SRS) resources of an SRS resource set configured by a cellular wireless network and receives SRS indicator (SRI) values and/or transmit precoder matrix indicator (TPMI) values to indicate antennas for subsequent uplink transmission of a physical layer channel by the wireless device, such as a physical uplink shared channel (PUSCH). The wireless device maps antennas of the wireless device to SRS resources of an SRS resource set to improve performance for non-coherent and coherent uplink (UL) multiple-input multiple-output (MIMO) transmissions. In some embodiments, the wireless device indicates a strongest antenna within an antenna group associated with an SRS resource using a TPMI Group value. In some embodiments, a base station determines whether SRS and/or PUSCH transmissions are maximum transmit power level (MTPL) limited and adjusts parameters used for antenna selection accordingly.

### FIELD

The described embodiments relate to wireless communications, including methods and apparatus to manage antenna selection for a multiple transmitter wireless device.

### BACKGROUND

Newer generation, e.g., fifth generation (5G) new radio (NR), cellular wireless networks that implement one or more 3^{rd} Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency of 5G is expected to usher in a range of new applications and services as well as improve existing ones. A wireless device sends in the uplink (UL) direction to a cellular wireless network one or more sounding reference signal (SRS) transmissions configured by the cellular wireless network to the wireless device to measure UL channels for subsequent UL data and/or control signal transmissions. A single or dual transmitter wireless device can include multiple, e.g., four, receivers that can process signals received via multiple antennas (which in some cases can be mapped via a receiver transform filter matrix to one or more antenna ports that feed the receivers). With fewer transmitters than receivers, the wireless device can transmit in the uplink direction using one or two antenna ports (which in the simplest case can be mapped directly to two distinct physical antennas) at any given time instant. Different antennas (or equivalently antenna ports) can provide different UL transmission characteristics based on how the wireless device is being used, e.g., device physical orientation, antenna blockage, etc. Performance of UL transmission can vary for the different individual antennas and for different antenna pairs. The wireless device can select an antenna or antenna pair to use based on an open-loop antenna selection procedure, e.g., using measured downlink (DL) signal strength and/or signal quality metrics to infer UL channel characteristics or based on a closed-loop antenna selection procedure, e.g., using an antenna selection provided in a message from the cellular wireless network in response to measurements taken by the cellular wireless network based on reception of the UL SRS transmissions sent by the wireless device. Present mechanisms map SRS signals to antenna ports (or antennas) arbitrarily, which can result in poor performance when different antenna ports (or antennas) within a group of antenna ports (or antennas) have significantly different uplink channel characteristics. There exists a need for mechanisms to map SRS signals to antenna ports (or antennas) to achieve higher performance for both non-coherent and coherent UL transmissions.

### SUMMARY

This application relates to wireless communications, including methods and apparatus to manage antenna selection for a multiple transmitter wireless device. A cellular wireless network configures one or more sounding reference signal (SRS) resource sets to the wireless device, each SRS resource set including multiple SRS resources for uplink (UL) transmission and each SRS resource including multiple SRS ports. Each SRS resource set is designated for a particular usage, such as a codebook usage for UL sounding (which can be used for closed-loop antenna selection and/or UL precoder selection) or an antenna switching usage (which can be used for DL precoder selection). The wireless device measures one or more downlink performance metrics, e.g., signal strength and/or signal quality, through each of multiple antennas (or antenna ports) and maps groups of antennas (or antenna ports) to SRS resources that have multiple SRS ports each, where the mapping accounts for the measured downlink performance metrics of the individual antennas (or antenna ports). In some embodiments, each group of antennas (or antenna ports) includes two antennas (or antenna ports), and each SRS resource in an SRS resource set includes two SRS ports. The wireless device can select groups of antennas (or antenna ports) with similar downlink performance or use a ranked ordering of the antennas (or antenna ports) based on the measured downlink performance.

In a representative embodiment, a two transmit chain, four receive chain (2T4R) wireless device is configured with an SRS resource set designated for codebook usage and which includes two SRS resources, with two SRS ports each, and the two best antennas (or antenna ports) are mapped to a first SRS resource, while the two worst antennas (or antenna ports) are mapped to a second SRS resource. The wireless device transmits the SRS resources to a base station of the cellular wireless network via the antennas (or antenna ports) using the mapping, and the base station of the cellular wireless network selects an antenna pair for subsequent UL physical layer channel transmission, e.g., for a physical uplink shared channel (PUSCH) transmission by sending a downlink control information (DCI) message that includes an SRS indicator (SRI) value that indicates an SRS resource associated with the selected antenna pair. In some embodiments, the DCI further includes a transmit precoding matrix indicator (TPMI) value that specifies an UL precoder for the wireless device to use with the PUSCH transmission. The wireless device can monitor the downlink performance via the antennas (or antenna ports) and update the mapping, e.g., periodically, at scheduled times, on demand, or based on measurement triggering criteria.

In another representative embodiment, the 2T4R wireless device is configured with an SRS resource set designated for codebook usage and which includes one SRS resource with two SRS ports, and the two best antennas (or antenna ports) are selected by the wireless device and mapped to the single SRS resource of the SRS resource set. The wireless device transmits the SRS resource to the base station, which responds with a TPMI value that specifies an UL precoder for PUSCH transmission. The wireless device can monitor the performance of multiple antennas (or antenna ports) and change which two best (or selected) antennas (or antenna ports) are mapped to the two SRS ports of the single SRS resource of the SRS resource set prior to an UL SRS transmission to cause the base station to measure UL channels via the newly mapped antennas (or antenna ports) for subsequent UL transmission via the newly mapped antennas (or antenna ports).

The maximum transmit power level (MTPL) of different antennas (or antenna ports) of the wireless device when using a particular frequency band can vary. When the MTPL between different antennas (or antenna ports) within each group of antennas (or antenna ports) that can be used by a wireless device satisfy an MTPL difference threshold, the wireless device can indicate a strongest antenna (or antenna port) for each group of antennas (or antenna ports) to a base station of a cellular wireless network by sending a particular TPMI Group value to the base station and map the strongest antenna (or antenna port) of each group of antennas to the identical (e.g., first) SRS port of the corresponding SRS resource to which the group of antennas (or antenna ports) is associated. When the MTPL difference between individual antennas (or antenna ports) of at least one group of antennas (or antenna ports) usable by the wireless device do not satisfy the MTPL difference threshold, the wireless device does not report a particular TPMI Group value to the base station. Due to hardware limitations, in some cases, not all combinations of antennas (or antenna ports) can be grouped together, and therefore only certain combinations of antennas (or antenna ports) may be used to form a group of antennas for a particular wireless device.

In some embodiments, the base station determines whether an MTPL value for an SRS resource transmission or a PUSCH transmission by the wireless device is limited. The base station can use a power headroom (PH) value included in a power headroom report (PHR) provided by the wireless device to determine whether the PUSCH transmission is MTPL limited. The base station can use the PH value, scaled by a ratio of bandwidth used for the SRS resource transmission and bandwidth used by the PUSCH transmission, to determine whether the SRS resource transmission is MTPL limited. When the PUSCH transmission is MTPL limited, the base station can adjust a received SRS resource transmission measurement by an adjustment factor, e.g., increase the received SRS value by 3 dB. When the SRS resource transmission is MTPL limited, the base station can adjust a received SRS resource transmission measurement by another adjustment factor, e.g., decrease the received SRS value by 3 dB. By adjusting the received SRS resource transmission measurement, which can be used for selecting an antenna (or antenna port), the base station compensates for the MTPL limitation of the SRS resource or PUSCH transmission and improves accuracy of antenna selection.

In some embodiments, a wireless device that uses coherent UL multiple-input multiple-output (MIMO) transmission calculates a channel capacity for groups of antennas (or antenna ports) that can be used together for the UL MIMO transmission and selects antenna groups to map to SRS ports of SRS resources of an SRS resource set designated for codebook usage based on the calculated channel capacities. The wireless device can monitor a downlink signal metric, such as a signal strength or signal quality, e.g., a reference signal received power (RSRP) value or a signal-to-noise-plus-interference (SINR) value, and determine a scaling factor to adjust channel information estimates for each antenna (or antenna port). The scaling factor can also include transmit and receive characteristics of the respective antennas (or antenna ports), such as total radiated power (TRP) and total isotropic sensitivity (TIS) values. The wireless device determines a mutual correlated channel information matrix for pairs (or other groupings) of antennas (or antenna ports) and selects the best antenna (or antenna port) combinations to map to the SRS resources in an SRS resource set designated for codebook usage using a mutual channel capacity derived from the mutual correlated channel information matrix, such as based on eigenvalues of the mutual correlated channel information matrix.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a diagram of an example of a sounding reference signal (SRS) resource set used for downlink (DL) precoding for a 1T4R wireless device, according to some embodiments.

FIG. 1B illustrates a diagram of an example of an SRS resource set used for uplink (UL) sounding for a 1T4R wireless device, according to some embodiments.

FIG. 1C illustrates a diagram of an example of an SRS resource set used for UL sounding and SRS indicator (SR) antenna selection for a 1T4R wireless device, according to some embodiments.

FIG. 1D illustrates a diagram of an example of an SRS resource set used for DL precoding for a 2T4R wireless device, according to some embodiments

FIG. 1E illustrates a diagram of an example of an SRS resource set used for UL sounding and SRS indicator (SRI) based antenna selection for a 2T4R wireless device, according to some embodiments.

FIG. 1F illustrates a diagram of another example of an SRS resource set used for DL precoding for a 2T4R wireless device, according to some embodiments.

FIG. 2A illustrates an exemplary uplink transmit chain for a wireless device, according to some embodiments.

FIG. 2B illustrates an example of uplink transmit data processing for a wireless device, according to some embodiments.

FIG. 2C illustrates diagrams of exemplary UL multiple-input multiple-output (MIMO) precoding matrices with non-coherent antenna port selection, according to some embodiments.

FIG. 2D illustrates a table of exemplary maximum transmit power level (MTPL) values of individual antenna ports of a wireless device, according to some embodiments.

FIG. 3 illustrates tables of examples of mapping SRS resources to antenna ports for a 2T4R wireless device, according to some embodiments.

FIG. 4 illustrates a diagram of an example of device-based antenna mapping and network-based closed-loop antenna pair selection for a 2T4R wireless device, according to some embodiments.

FIG. 5A illustrates tables of examples of MTPL difference values for pairs of antenna ports of a 2T4R wireless device, according to some embodiments.

FIGS. 5B and 5C illustrate examples of antenna port selection with and without MTPL adjustment for a 2T4R wireless device, according to some embodiments.

FIG. 6 illustrates a flowchart of an exemplary method for UL transmit antenna selection for a wireless device, according to some embodiments.

FIG. 7 illustrates a flowchart of another exemplary method for UL transmit antenna selection for a wireless device, according to some embodiments.

FIG. 8A illustrates a flowchart of a further exemplary method for UL transmit antenna selection for a wireless device, according to some embodiments.

FIG. 8B illustrates a flowchart of an exemplary method for calculating a channel capacity of an antenna port group by a wireless device, according to some embodiments.

FIG. 9 illustrates a flowchart of an additional exemplary method for UL transmit antenna selection for a wireless device, according to some embodiments.

FIG. 10 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus to manage antenna selection for a multiple transmitter wireless device. A cellular wireless network configures one or more sounding reference signal (SRS) resource sets to the wireless device, each SRS resource set including one or more SRS resources for uplink (UL) transmission, where each SRS resource can include multiple SRS ports for simultaneous UL transmission via multiple antennas (or more generally antenna ports). The wireless device can be configured with multiple SRS resources sets used for different purposes, such an SRS resource set designated for “antenna switching” usage for UL channel measurements to select a downlink (DL) precoder (assuming reciprocity for time-division duplexing communication or compensating for differences across carriers in different frequency bands for frequency-division duplexing communication) or an SRS resource set designated for “codebook” usage for UL channel sounding for a base station to measure UL channel characteristics and determine antennas and an UL precoder for subsequent UL transmissions. The wireless device can be configured with different SRS resource sets that include different sets of SRS resources. The wireless device transmits the SRS resources periodically, when designated periodic, or triggered by a downlink control information (DCI), when designated aperiodic, to the cellular wireless network via one or more antenna ports. SRS ports of SRS resources can be mapped via a spatial filter to physical antennas; however, to simplify description here, it is assumed that individual SRS resources map to antennas directly. The ideas described here can also apply to mapping of SRS resources (or SRS ports) to antenna ports that map to combinations of physical antennas (e.g., UL beam-forming) as well. Each SRS resource set is designated with a usage configuration parameter indicating how the SRS resource set is to be used. The SRS resource sets described herein are designated with a codebook usage to be used for UL channel measurements and estimation with subsequent use for transmission of physical layer channels, specifically a physical uplink shared channel (PUSCH).

The wireless device signals its transmission capability regarding antenna switching to the cellular wireless network. A wireless device with only one transmit chain and four receive chains, denoted as a 1T4R capability, can only provide partial sounding (i.e., full sounding by sending different SRS resources via all four antennas at once is not supported) and therefore antenna switching is required to sound all of the different possible uplink channels via the four different antennas (or more generally via four antenna ports that correspond to individual antennas or combinations of antennas of the wireless device). A wireless device with two transmit chains and four receive chains, denoted as a 2T4R capability, can provide partial sounding via two antennas (or antenna ports) at a time, and can provide full sounding by switching among pairs of antennas. A wireless device with four transmit chains and four receive chains, denoted as a 4T4R capability, can provide full sounding by sending different SRS resources via all four antennas at once.

The wireless device measures one or more downlink performance metrics, e.g., signal strength or signal quality, through each of multiple antennas (or antenna ports) and maps groups of antennas (or antenna ports) to SRS resources that have multiple SRS ports each, where the mapping accounts for the measured downlink performance metrics of the individual antennas (or antenna ports). In some embodiments, each group of antennas (or antenna ports) includes two antennas (or antenna ports), and each SRS resource in an SRS resource set includes two SRS ports. The wireless device can select groups of antennas (or antenna ports) with similar downlink performance or use a ranked ordering of the antennas (or antenna ports) based on the measured downlink performance. In a representative embodiment, a 2T4R wireless device is configured with an SRS resource set designated for codebook usage and which includes two SRS resources, with two SRS ports each, and the two best antennas (or antenna ports) are mapped to a first SRS resource, while the two worst antennas (or antenna ports) are mapped to a second SRS resource. The wireless device transmits the SRS resources to a base station of the cellular wireless network via the antennas (or antenna ports) using the mapping, and the base station of the cellular wireless network selects an antenna pair for subsequent UL physical layer channel transmission, e.g., for a physical uplink shared channel (PUSCH) transmission by sending a downlink control information (DCI) message that includes an SRS indicator (SRI) value that indicates an SRS resource associated with the selected antenna pair. The wireless device can monitor DL performance and change the mapping of antennas (or antenna ports) to SRS resources based on the monitored DL performance, e.g., to account for changes in antenna performance individually and relative to each other. In some embodiments, the DCI further includes a transmit precoding matrix indicator (TPMI) value that specifies an UL precoder for the wireless device to use with the PUSCH transmission. The wireless device can monitor the downlink performance via the antennas (or antenna ports) and update the mapping, e.g., periodically, at scheduled times, on demand, or based on measurement triggering criteria.

In another representative embodiment, the 2T4R wireless device is configured with an SRS resource set designated for codebook usage that includes one SRS resource with two SRS ports, and two best antennas (or antenna ports) are selected by the wireless device and mapped to the SRS resource. The wireless device transmits the SRS resource to the base station, which responds with a TPMI value that specifies an UL precoder for PUSCH transmission. The wireless device can monitor the performance of multiple antennas (or antenna ports) and change which two best (or selected) antennas (or antenna ports) are mapped to the two SRS ports of the SRS resource prior to an UL SRS transmission to cause the base station to measure UL channels via the newly mapped antennas (or antenna ports) for subsequent UL transmission via the newly mapped antennas (or antenna ports).

In some embodiments, the 2T4R wireless device supports UL MIMO transmission with multiple data layers. Presently, the 3GPP communications standards specify a single, common modulation and coding scheme (MCS) value for the multiple data layers, even though performance through different antennas can vary. UL performance via better data layers can be limited by an MCS value selected to accommodate poorer data layers, e.g., when each data layer is transmitted separately via an individual antenna (or antenna port), and the performance of the individual antennas differ substantially. A large signal performance imbalance, such as a difference of 20 dB, between different antennas has been observed in wireless devices operating in a cellular wireless network. In addition, Doppler shift and multi-path interference can result in different propagation attenuation for different antennas of the wireless device also impacting performance and contributing to imbalance between different antennas. Mapping the antennas (or antenna ports) based on measured performance and/or known characteristics of the antennas can improve UL throughput.

The maximum transmit power level (MTPL) of different antennas (or antenna ports) of the wireless device when using a particular frequency band can also vary between the different antennas (or antenna ports). When the MTPL between different antennas (or antenna ports) within each group of antennas (e.g., pairs of antennas) that can be used for UL transmission by a wireless device satisfy an MTPL difference threshold, the wireless device can indicate a strongest antenna for each group of antennas to a base station of a cellular wireless network. For example, a 2T4R wireless device can provide an indication to a base station when antennas within each usable antenna pair have MTPL values that differ by at least an MTPL different threshold, such as 3 dB. (Not all antenna pairs of a wireless device may be usable for MIMO UL transmission due to hardware limitations of the wireless device.) The wireless device can provide the indication of the strongest antenna of antenna groups by sending a particular TPMI Group value to the base station and map the strongest antenna of each available group of antennas to the identical (e.g., first) SRS port of a corresponding SRS resource to which the group of antennas is associated. With the MTPL mapping of antennas to SRS ports by the wireless device, which can know performance limitations of the different antennas, and with the indication of a particular SRS resource port of each SRS resource being associated with a strongest transmitting (highest MTPL value within an antenna group), the base station can account (at least in part) for the difference in MTPL values. When the MTPL difference between individual antennas (or antenna ports) of at least one group of antennas (or antenna ports) usable by the wireless device do not satisfy the MTPL difference threshold, e.g., fall below 3 dB, the wireless device can refrain from reporting a particular TPMI Group value to the base station. The MTPL value for individual antennas can vary for different radio frequency (RF) bands used by the wireless device, and therefore when using some RF bands, the wireless device may provide a TPMI Group value to the base station, while when using other RF bands, the wireless device may not provide a TPMI Group value to the base station.

In some embodiments, the base station determines whether an MTPL value for an SRS resource transmission or a PUSCH transmission by the wireless device is limited. The base station can use a power headroom (PH) value included in a power headroom report (PHR) provided by the wireless device to determine whether the PUSCH transmission is MTPL limited. The base station can use the PH value, scaled by a ratio of bandwidth used for the SRS resource transmission and bandwidth used by the PUSCH transmission, to determine whether the SRS resource transmission is MTPL limited. When the PUSCH transmission is MTPL limited, the base station can adjust a received SRS resource transmission measurement by an adjustment factor, e.g., increase the received SRS value by 3 dB. When the SRS resource transmission is MTPL limited, the base station can adjust a received SRS resource transmission measurement by another adjustment factor, e.g., decrease the received SRS value by 3 dB. By adjusting the received SRS resource transmission measurement, which can be used for selecting an antenna (or antenna port), the base station compensates (at least in part) for the MTPL limitation.

In some embodiments, a wireless device that uses coherent UL multiple-input multiple-output (MIMO) transmission calculates a channel capacity for groups of antennas (or antenna ports) that can be used together for the UL MIMO transmission and selects antenna groups to map to SRS ports of SRS resources of an SRS resource set designed for codebook usage based on the calculated channel capacities. The wireless device estimate channel information for each antenna of the wireless device. The wireless device can also monitor a downlink signal metric, such as a signal strength or signal quality, e.g., reference signal received power (RSRP) value or signal-to-noise-plus-interference (SINR) value, and determine a scaling factor to adjust estimated channel information for each antenna. The scaling factor can include transmit and receive characteristics of the respective antennas, such as total radiated power (TRP) and total isotropic sensitivity (TIS) values for the antennas. The wireless device determines a mutual correlated channel information matrix for pairs (or other groupings) of antennas and selects antenna combinations to map to the SRS resources using a mutual channel capacity derived from the mutual correlated channel information matrix, such as based on eigenvalues of the mutual correlated channel information matrix.

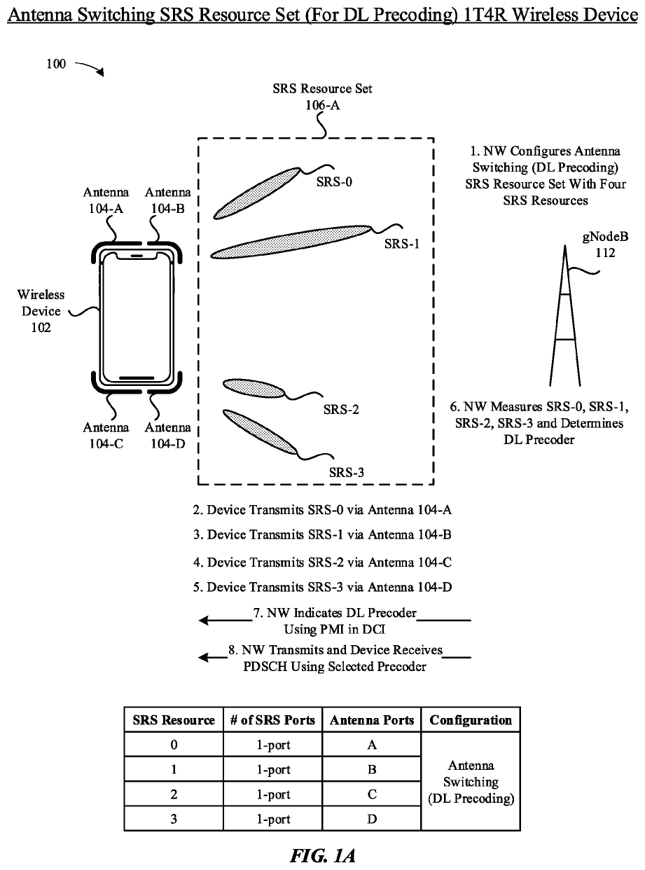

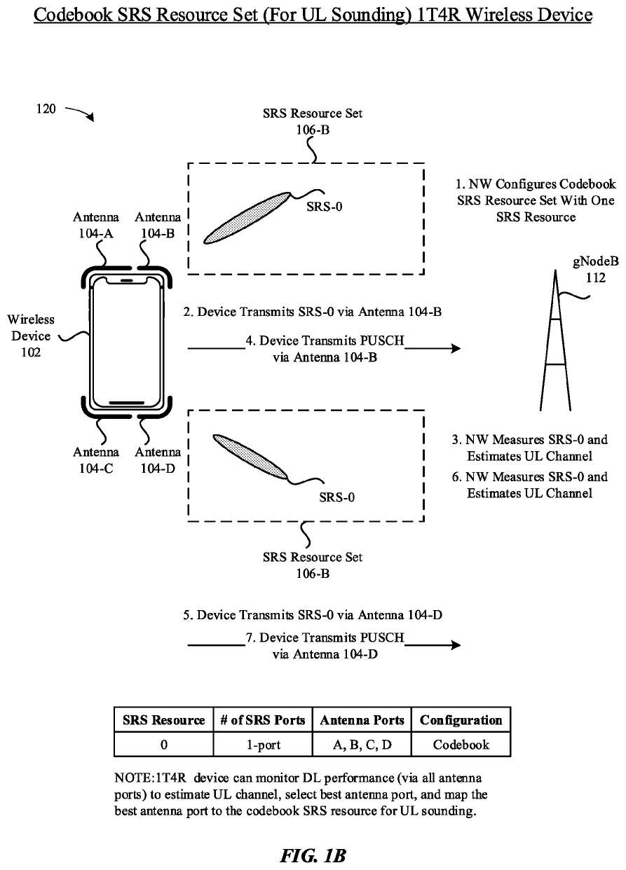

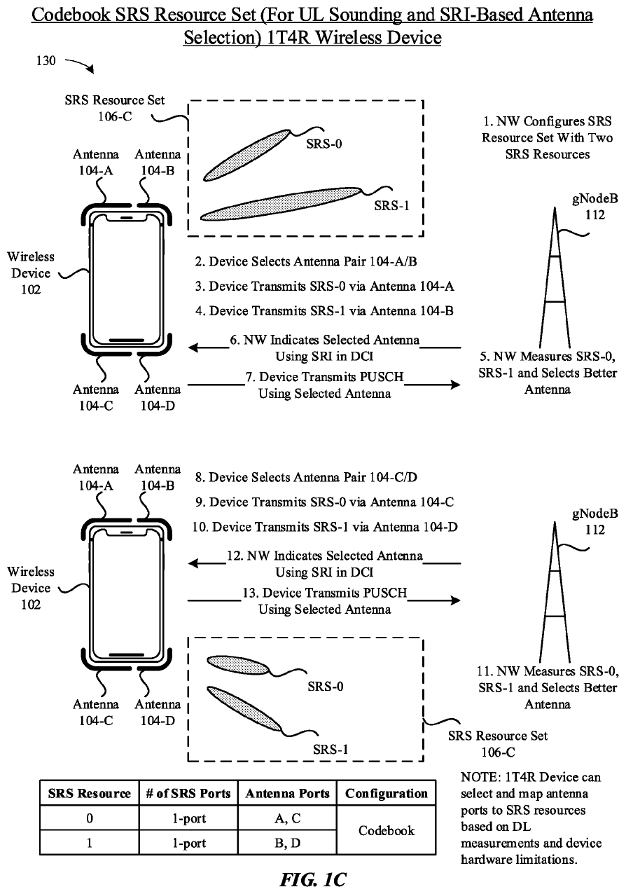

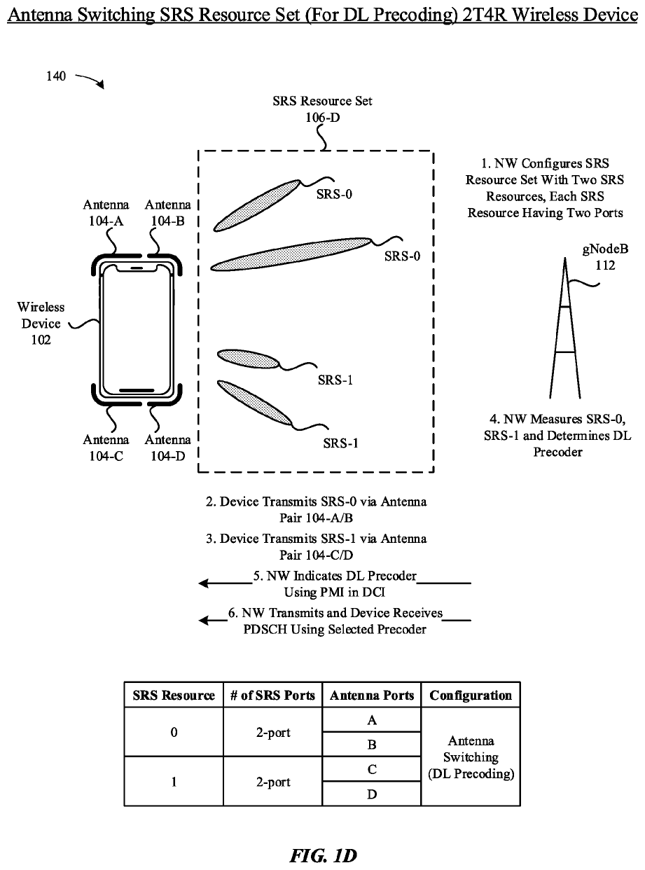

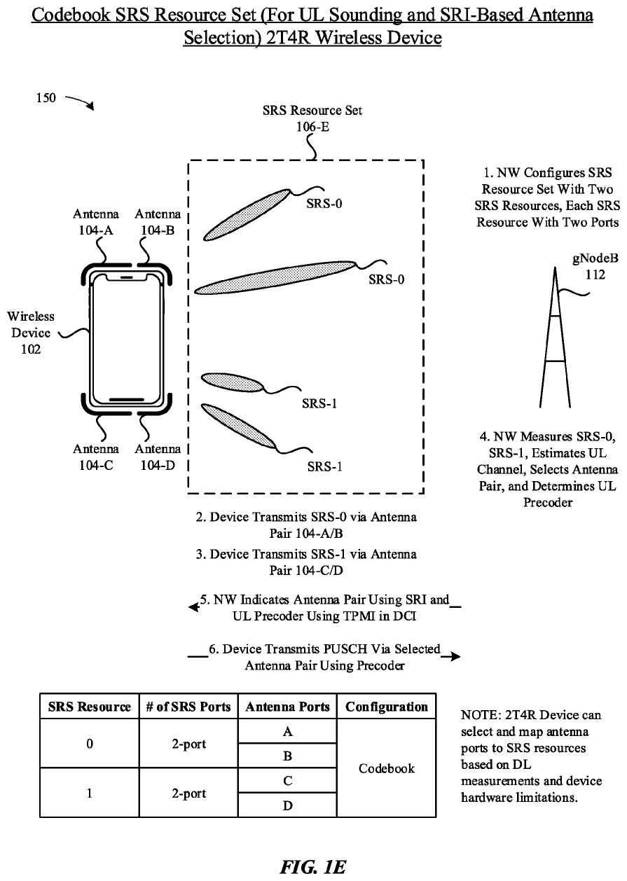

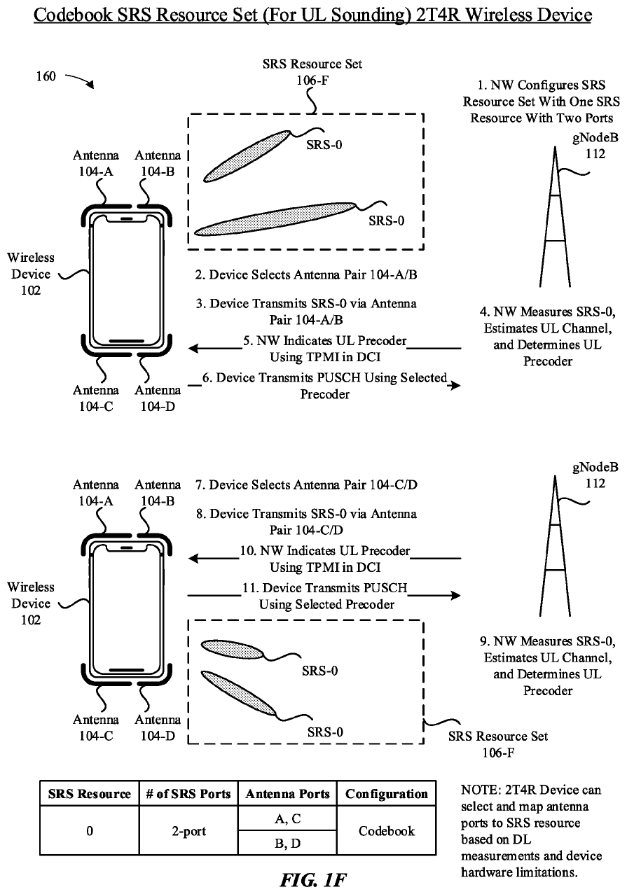

These and other embodiments are discussed below with reference to FIGS. 1A through 10; however, those skilled in the art will readily appreciate that the detailed description given herein with respect to these figures is for explanatory purposes only and should not be construed as limiting.

FIG. 1A illustrates a block diagram 100 of an exemplary system configured to implement downlink (DL) precoding selection based on an uplink (UL) sounding reference signal (SRS) resource set designated for “antenna switching” for a wireless device 102. The wireless device 102 includes a single transmitter (transmit chain) and multiple receivers (receive chains) communicatively coupled to multiple antennas 104-A, 104-B, 104-C, and 104-D. The single transmitter of the wireless device 102 can send uplink (UL) signals via an individual antenna 104-A/B/C/D to a gNodeB 112 (base station) of a cellular wireless network and receive one or more downlink (DL) signals from the gNodeB 112 via one or more of the multiple antennas 104-A/B/C/D. The wireless device 102 can indicate to the gNodeB 112 of the cellular wireless network the transmit and receive capability of the wireless device 102, e.g., a one-transmit, four-receive configuration, designated as 1T4R, for the wireless device 102. Based on how the wireless device 102 is being used, transmissions via different antennas 104-A/B/C/D can experience different uplink channel conditions to the gNodeB 112, based on orientation of the wireless device 102 and/or based on adjacent (or nearby) objects that block or interfere with radio frequency (RF) signals between the wireless device 102 and the gNodeB 112.

The gNodeB 112 can configure the wireless device 102 with a sounding reference signal (SRS) resource set 106-A that includes four SRS resources, SRS-0, SRS-1, SRS-2, and SRS-3. In some embodiments, the gNodeB 112 configures the wireless device 102 with multiple SRS resource sets 106, where each SRS resource set 106 can be used for different purposes. The SRS resource set 106-A can be designated for measuring UL transmission characteristics by the gNodeB 112 and determining a DL precoder for transmission of signals from the gNodeB 112 to the wireless device 102. Such usage for the SRS resource set 106-A can also be referred to as “antenna switching”, as the single-transmitter wireless device 102 can switch between different antennas to transmit the different SRS resources of the SRS resource set 106-A to the gNodeB 112.

SRS resource sets 106 can be designated for periodic, semi-persistent, or aperiodic transmission. In some embodiments, the SRS resource set 106 configured to the wireless device 102 is designated as periodic, and the gNodeB 112 expects the wireless device 102 to periodically transmit the SRS resources of the SRS resource set 106 to measure UL channels. In some embodiments, the SRS resource set 106 configured to the wireless device 102 is designated as aperiodic, and the gNodeB 112 sends a downlink control information (DCI) message to the wireless device 102 to trigger transmission of the SRS resources of the SRS resource set 106 at specified times for UL channel measurement.

The wireless device 102 transmits the four SRS resources, SRS-0, SRS-1, SRS-2, and SRS-3 sequentially via the individual antennas (or antenna ports) 104-A, 104-B, 104-C, and 104-D respectively during one or more orthogonal frequency division modulation (OFDM) symbols of a slot of an UL OFDM frame sent to the gNodeB 112. The gNodeB 112 of the cellular wireless network measures the received SRS resource signals SRS-0, SRS-1, SRS-2, and SRS-3 and selects a DL precoder to use for subsequent DL transmissions based on the measurements of the received SRS resource signals SRS-0, SRS-1, SRS-2, and SRS-3. The gNodeB 112 provides an indication of the DL precoder selected by sending precoding matrix index (PMI) value to the wireless device 102. The gNodeB 112 subsequently sends precoded transmissions to the wireless device 102 using the selected DL precoder.

FIG. 1B illustrates a diagram 120 of an example of an SRS resource set 106-B used for UL sounding by a wireless device 102. A base station, e.g., gNodeB 112, configures the wireless device 102 with the SRS resource set 106-B designated for UL sounding, also referred to as codebook usage. In the example of FIG. 1B, the SRS resource set 106-B includes one SRS resource, SRS-0, which can be transmitted by the wireless device 102 through any one of the antennas 104-A, 104-B, 104-C, and 104-D of the wireless device 102 using one or more OFDM symbols of a slot. The wireless device 102 can monitor DL performance received via all of the antennas 104-A/B/C/D to estimate an UL channel and select a best antenna to use for UL transmissions to the gNodeB 112 at any given time. The wireless device 102 can map the SRS resource SRS-0 to the best antenna identified and send the SRS resource SRS-0 to the gNodeB 112 to allow the gNodeB 112 to measure the UL channel via the selected antenna. The gNodeB 112 can measure the received SRS resource SRS-0 and estimate the UL channel for subsequent UL transmissions to be received from the wireless device 102. The wireless device can select different antennas at different times to map to the SRS resource SRS-0 prior to sending the SRS resource SRS-0 to the gNodeB 112. In the example of FIG. 1B, the wireless device 102 performs open loop antenna selection (based on DL measurements and without feedback from the gNodeB 112), and the gNodeB 112 adapts receiver parameters based on reception of the SRS resource SRS-0.

FIG. 1C illustrates a diagram 130 of an example of an SRS resource set used for UL sounding and closed-loop antenna selection based on an SRS indicator (SRI) value provided by a gNodeB 112 to a wireless device 102. The wireless device 102 can indicate to the gNodeB 112 the transmit and receive capability of the wireless device 102, e.g., a one-transmit, four-receive configuration, designated as 1T4R, for the wireless device 102. Based on how the wireless device 102 is being used, transmissions via different antennas 104-A/B/C/D can experience different uplink channel conditions to the gNodeB 112, based on orientation of the wireless device 102 and/or based on adjacent (or nearby) objects that block or interfere with radio frequency (RF) signals between the wireless device 102 and the gNodeB 112. The gNodeB 112 can configure the wireless device 102 with a sounding reference signal (SRS) resource set 106-C that includes two SRS resources, SRS-0 and SRS-1, each SRS resource having a single SRS port. The SRS resource set 106-C can be designated for use with a specific UL physical layer channel, e.g., the physical uplink shared channel (PUSCH). The wireless device 102 selects an antenna pair, e.g., 104-A/B, and transmits the two SRS resources, SRS-0 and SRS-1, sequentially to the gNodeB 112 via the individual antennas (or antenna ports) 104-A and 104-B respectively during one or more OFDM symbols of a slot of an UL OFDM frame. The gNodeB 112 of the cellular wireless network measures the received SRS resource signals SRS-0 and SRS-1 and selects an antenna of the antenna pair for the wireless device 102 to subsequently use for PUSCH transmission based on the measurements of the received SRS resource signals SRS-0 and SRS-1. The gNodeB 112 provides an indication of the antenna selected by sending an SRS indicator (SRI) value to the wireless device 102 designating the SRS resource signal that corresponds to the selected antenna. For example, with a one-bit valued SRI, an SRI value of ‘0’, can correspond to SRS-0, while an SRI value of ‘1’ can correspond to SRS-1. The wireless device 102 knows through which antenna (or antenna port) 104-A or 104-B the different SRS resource signals SRS-0 and SRS-1 were transmitted and can infer an antenna selection from the SRI value. The wireless device 102 subsequently transmits the PUSCH using the selected antenna 104-A or 104-B to the gNodeB 112.

The wireless device 102 can determine to switch to using a different antenna pair, e.g., antennas 104-C/D, such as based on measured DL performance via the different antennas 104-A/B/C/D and determining the antenna pair 104-C/D may provide better UL performance than a presently used antenna pair 104-A/B. In some embodiments, certain antenna pair combinations can be allowed while other antenna pair combinations can be disallowed based on hardware limitations of the wireless device 102. The wireless device 102 can transmit the SRS resources, SRS-0 and SRS-1, to the gNodeB 112 sequentially via the individual antennas (or antenna ports) 104-C and 104-D respectively during one or more OFDM symbols of a slot of an UL OFDM frame. The gNodeB 112 of the cellular wireless network measures the received SRS resource signals SRS-0 and SRS-1 and selects an antenna for the wireless device 102 to subsequently use for PUSCH transmission based on the measurements of the received SRS resource signals SRS-0 and SRS-1. The gNodeB 112 provides an indication of the antenna selected by sending another SRI value to the wireless device 102 designating the SRS resource signal that corresponds to the selected antenna. The wireless device 102 again knows through which antenna (or antenna port) 104-C or 104-D the different SRS resource signals SRS-0 and SRS-1 were transmitted and can infer an antenna selection from the SRI value. The wireless device 102 subsequently transmits the PUSCH using the selected antenna 104-C or 104-D to the gNodeB 112.

FIG. 1D illustrates a diagram 140 of an example of an SRS resource set 106-D designated for “antenna switching” and used for determination of a DL precoder for a 2T4R wireless device 102. A base station, e.g., gNodeB 112, of a cellular wireless network configures the wireless device 102 with the SRS resource set 106-D, which includes two SRS resources, SRS-0 and SRS-1, where each SRS resource includes two SRS ports. The wireless device 102 associates SRS-0 with antenna ports A/B and SRS-1 with antenna ports C/D. The wireless device 102 includes two transmit chains and can transmit via two antennas (or antenna ports) at the same time. The wireless device 102 transmits SRS-0 via antenna ports 104-A and 104-B to the gNodeB 112 during one or more OFDM symbols of a slot of an OFDM frame. The wireless device 102 subsequently transmits SRS-1 via antenna ports 104-C and 104-D to the gNodeB 112 during one or more OFDM symbols of a slot of an OFDM frame. The gNodeB 112 measures received versions of the SRS resources SRS-0 and SRS-1 and determines a DL precoder to use for DL transmissions to the wireless device 102. The gNodeB 112 transmits a downlink control information (DCI) message to the wireless device 102, the DCI message including a PMI value to indicate the selected precoder that the gNodeB 112 will use for subsequent precoded DL transmissions, e.g., via a physical downlink shared channel (PDSCH), to the wireless device 102. The wireless device 102 can receive and decode the PDSCH with knowledge of the DL precoder used by the gNodeB 112.

FIG. 1E illustrates a diagram 150 of an example of an SRS resource set 106-E used for UL sounding and SRS indicator (SRI) based antenna selection for a 2T4R wireless device 102. A gNodeB 112 of a cellular wireless network configures the wireless device 102 with an SRS resource set 106-E designated for codebook usage and which includes two SRS resources, SRS-0 and SRS-1, where each SRS resource includes two SRS ports. The wireless device 102 associates SRS-0 with antenna ports A/B and SRS-1 with antenna ports C/D. The wireless device 102 can determine which antenna ports to pair together based on DL measurements and on hardware limitations of the wireless device 102. The wireless device 102 includes two transmit chains and can transmit via two antenna ports at the same time. The wireless device 102 transmits SRS-0 via antenna ports 104-A and 104-B to the gNodeB 112 during one or more OFDM symbols of a slot of an OFDM frame. The wireless device 102 subsequently transmits SRS-1 via antenna ports 104-C and 104-D to the gNodeB 112 during one or more OFDM symbols of a slot of an OFDM frame. The gNodeB 112 measures received versions of the SRS resources SRS-0 and SRS-1, estimates an UL channel, and selects an antenna pair for the wireless device 102 to use for subsequent UL transmissions, e.g., for PUSCH transmissions. The gNodeB 112 also determines an UL precoder for the wireless device 102 to use for the subsequent UL transmissions. The gNodeB 112 sends a DCI message to the wireless device 102, the DCI message including an SRI value indicating the SRS resource associated with the antenna pair selected by the gNodeB 112 for the wireless device 102 to use and a transmit PMI (TPMI) value indicating an UL precoder for the wireless device 102 to use for UL transmissions. The wireless device 102 subsequently transmits the PUSCH using the antenna pair selected by the gNodeB 112 (indicated by the SRI value) and using an UL precoder matrix selected by the gNodeB 112 (indicated by the TPMI value). Depending on the number of layers supported by the wireless device 102 for UL MIMO transmission, the precoding matrix can select one or both antennas of the antenna pair for the wireless device 102 to use when operating in a non-coherent mode.

FIG. 1F illustrates a diagram 160 of another example of an SRS resource set 106-F used for UL sounding by a 2T4R wireless device 102. A gNodeB 112 configures the wireless device 102 with an SRS resource set 106-F designated for codebook usage and which includes a single SRS resource SRS-0 that has two SRS ports. The wireless device 102 can group together pairs of antennas based on hardware capabilities of the wireless device 102 and select a pair of antennas to use for UL transmission based on DL measurements of signals received via the antennas 104-A/B/C/D. In the example of FIG. 1F, the wireless device 102 pairs together antennas 104-A and 104-B in a first antenna group and antennas 104-C and 104-D in a second antenna group. The wireless device 102 can select an antenna group, e.g., antenna pair 104-A/B, and transmit the SRS resource SRS-0 via the selected antenna group to the gNodeB 112. The gNodeB 112 measures a received version of SRS-0, estimates an associated UL channel, and determines an UL precoder for the wireless device 102 to use for subsequent transmissions. Unlike in the example of FIG. 1E, the wireless device 102 (and not the gNodeB 112) selects the antenna group (pair); however, the gNodeB 112 can select either antenna 104-A or 104-B or a combination of 104-A and 104-B for the wireless device 102 to use for UL transmissions based on the selected UL precoder. The gNodeB 112 sends a DCI message to the wireless device 102, the DCI message including a TPMI value indicating the selected UL precoder for the wireless device 102 to subsequently use. The wireless device 102 transmits the PUSCH to the gNodeB 112 using the selected precoder. The wireless device 102 can subsequently determine to switch between using the first antenna pair 104-A/B and the second antenna pair 104-C/D before sending the SRS resource SRS-0 to the gNodeB 112. The gNodeB 112 again measures a received version of SRS-0, estimates the UL channel, determines an UL precoder, and transmits a DCI message with a TPMI value indicating the determined UL precoder for the wireless device 102 to use subsequently when transmitting the PUSCH to the gNodeB 112.

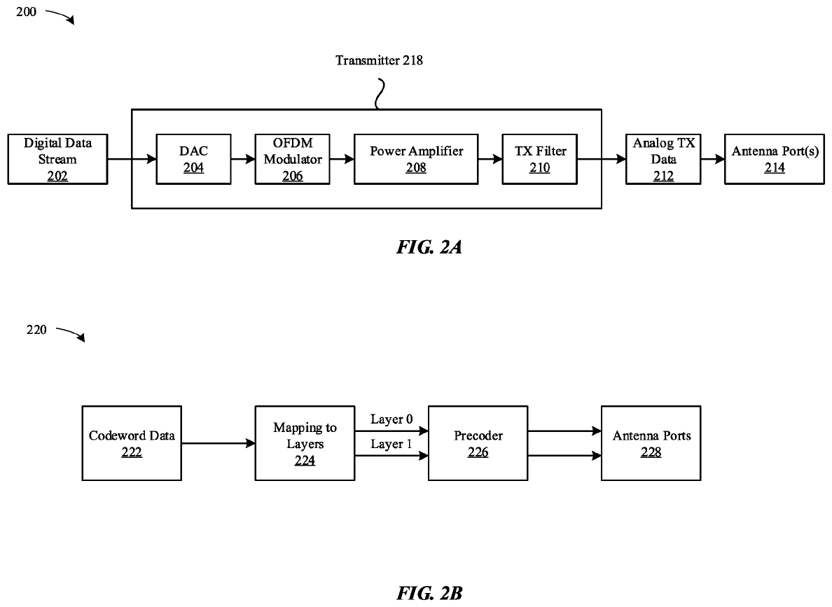

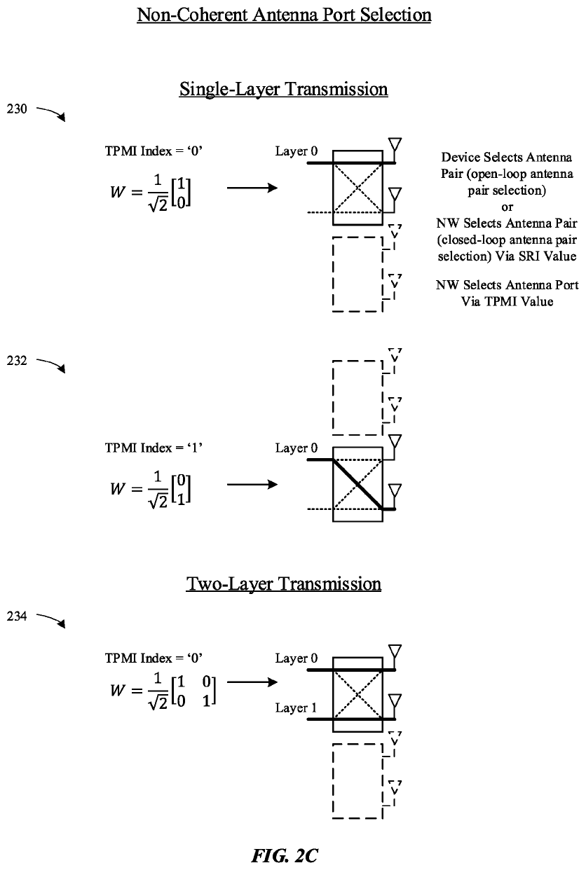

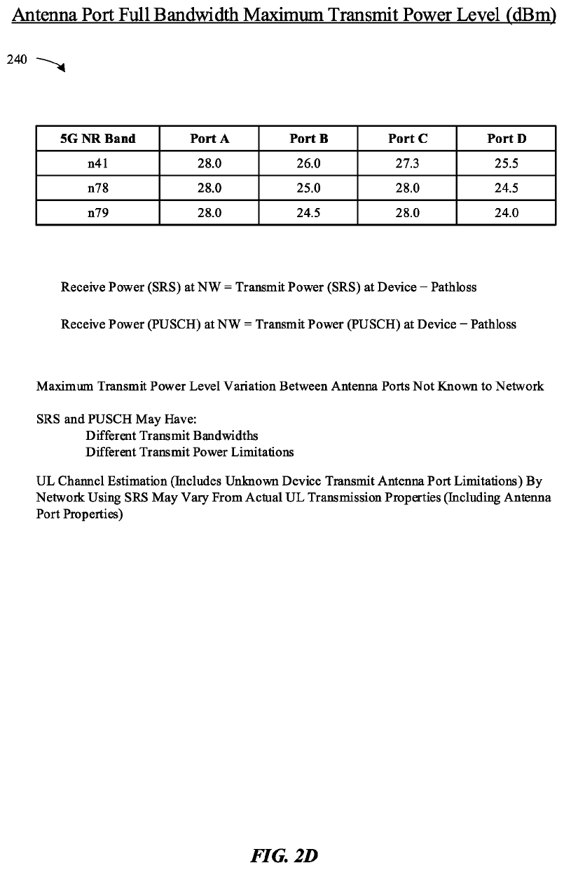

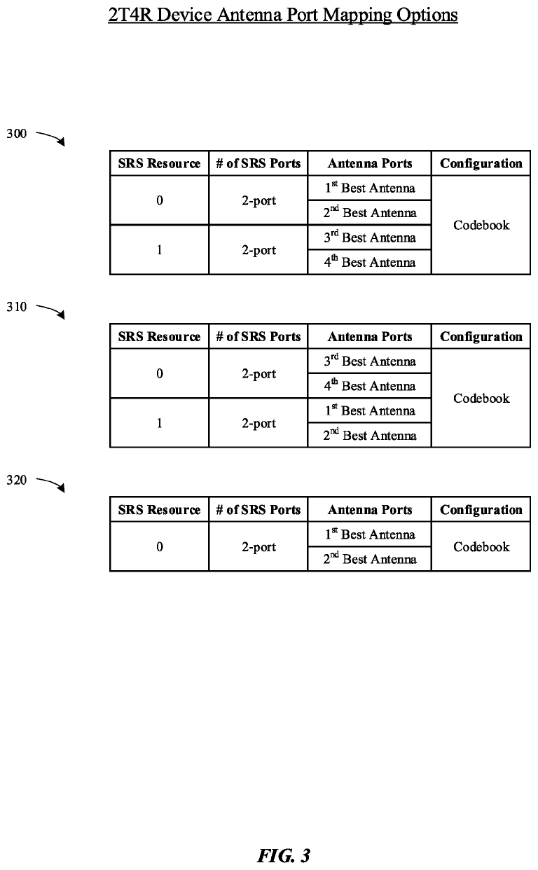

FIG. 2A illustrates a diagram 200 of an exemplary uplink transmit chain for the wireless device 102. A transmitter 218 can receive a digital data stream 202 for uplink data to be communicated wirelessly to a cellular wireless network through one or more antenna ports 214. A digital-to-analog converter (DAC) 204 of the transmitter 20 converts the digital data stream 202 into an analog signal which is modulated onto an uplink radio frequency (RF) carrier by an OFDM modulator 206 of the transmitter 218. The modulated analog signal is amplified by a power amplifier 208 and filtered through a suitable transmit (TX) filter 210 resulting in an amplified analog transmit data signal 212 that is transmitted wirelessly a radio link to a cellular wireless network via one or more antenna ports 214. When multiple antenna ports 214 (or antennas) are used, an UL transmission can be referred to as a multiple-input multiple-output (MIMO) transmission, and can be used to improve data throughput and/or transmission reliability. The UL transmission output from the antenna ports 214 of the wireless device 102 are transmitted at a power level to allow for proper reception by cells of the cellular wireless network. The UL transmissions are limited by the wireless circuitry of the transmitter 218 and the transmission properties of the antenna ports 214. The UL transmissions from all antenna ports 214 of the wireless device 102 are required to meet regulatory requirements, such as a specific absorption rate (SAR) limit for human exposure to radio frequency (RF) energy. A maximum transmit power limit (MTPL) can be determined by the wireless device 102 for transmission via radio links used for UL transmission. The MTPL for various transmissions can depend on an RF band that is used, a radio access technology (RAT) of the transmission, a bandwidth of the transmission, and physical properties of antennas via which the transmission occurs. Different antenna ports 214 can have different MTPL values for different transmissions in different RF bands of the same RAT.

FIG. 2B illustrates a diagram 220 of uplink transmit data processing for a wireless device 102. Codeword data 222 is input to a mapping block 224 that maps the codeword data to different layers for uplink multiple-input multiple-output (MIMO) transmission. The codeword data 222 is a stream of encoded bits, which is split by the mapping block 224 into individual layers of data. While only two layers are shown in FIG. 2B, the same principles of transmit data processing apply to higher numbers of layers. The individual layers are then mapped by a precoder 226 to different antenna ports 228. For non-coherent processing data from individual layers are mapped by the precoder 226 to individual antenna ports 228, while for coherent processing data from different layers can be combined by the precoder 226 to output to the antenna ports 228. For simplicity, the mapping to OFDM subcarriers and OFDM modulation prior to transmission by the physical antennas is not shown. The precoder 226 can be represented by a matrix operation where each column of the matrix corresponds to how individual layers are mapped to antenna ports 228.

FIG. 2C illustrates diagrams 230, 232, 234 of exemplary UL precoding matrices with non-coherent antenna port selection. For single layer transmission, as shown by diagrams 230, 232, only one layer (as shown, layer 0) of data is scaled and transferred by the precoder 226 to the antenna ports. Sets of precoder matrices for different numbers of transmit layers are defined in 3GPP cellular wireless communications standards. A base station, e.g., gNodeB 112, indicates a selected UL precoder for the wireless device 102 to use by sending a TPMI index value to the wireless device 102 in a DCI message. Different TPMI index values correspond to different precoding matrices. For single-layer transmission, a TPMI index value of ‘0’ corresponds to selection of a first antenna port of an antenna port group, as shown in diagram 230, while a TPMI index value of ‘1’ corresponds to selection of a second antenna port of the antenna port group. In some embodiments, the wireless device 102 selects an antenna port group (e.g., pair of antennas as illustrated in FIG. 2C) using an open-loop antenna port group selection procedure, such as based on DL performance monitoring via the different antenna ports. In some embodiments, the base station, e.g., gNodeB 112, of the cellular wireless network selects the antenna port group using a closed-loop antenna port group selection procedure, such as based on UL measurements of SRS signals, and indicates the selected antenna port group by sending an SRS indicator (SRI) value to the wireless device 102, e.g., in the DCI message with the TPMI value that selects the precoding matrix. For two-layer transmission, a TPMI index value of ‘0’ corresponds to mapping each layer independently to a separate antenna port of the antenna port group, e.g., layer 0 to a first antenna port and layer 1 to a second antenna port. The exemplary UL precoding matrices shown in FIG. 2C correspond to non-coherent transmission, where data from individual layers are only sent to individual antenna ports. Coherent transmission would allow for combining data from the individual layers before sending to the antenna ports.

FIG. 2D illustrates a table of exemplary maximum transmit power level (MTPL) values of individual antenna ports of a wireless device 102 when operating using different 5G new radio (NR) radio frequency bands. Physical hardware of the transmit chains that include the antenna ports can vary in MTPL capability. MTPL variation among antenna ports may be not known to the base station, e.g., gNodeB 112, of the cellular wireless network that measures UL SRS signals to determine an antenna group and/or antenna port(s) to use for subsequent UL transmissions, e.g., PUSCH transmissions sent by a wireless device 102 after SRS-based measurements and adaption by a base station, e.g., gNodeB 112. Measured receive power levels of an SRS signal at the base station include a pathloss attenuation that decreases the transmit power level of the SRS signal sent by the wireless device 102. The base station can estimate the pathloss based on the SRS signal; however, the base station is not aware of different MTPL values for different antenna ports of the wireless device 102. The SRS signal, in some circumstances can be restricted in transmit power level based on the MTPL value. A subsequent PUSCH transmission may be not restricted in transmit power level, e.g., when the SRS signal uses a wide bandwidth while the PUSCH transmission uses a narrow bandwidth. As a result, the base station can attribute an MTPL limitation of the SRS transmission via an antenna port to pathloss for the antenna port and choose a different antenna port for the PUSCH transmission, even though the PUSCH transmission may be not MTPL limited when transmitted via the antenna port that was MTPL limited for the SRS transmission. Alternatively, the SRS transmission may be not MTPL limited, while the subsequent PUSCH transmission may be MTPL limited, which can also result in an error in UL channel pathloss estimation and selection of antenna ports by the base station. As described further herein, the base station can estimate whether SRS transmissions and/or PUSCH transmissions are MTPL limited and compensate for the MTPL limitation when evaluating UL performance and selecting an antenna port group and/or antenna port for use for PUSCH transmission by the wireless device 102.

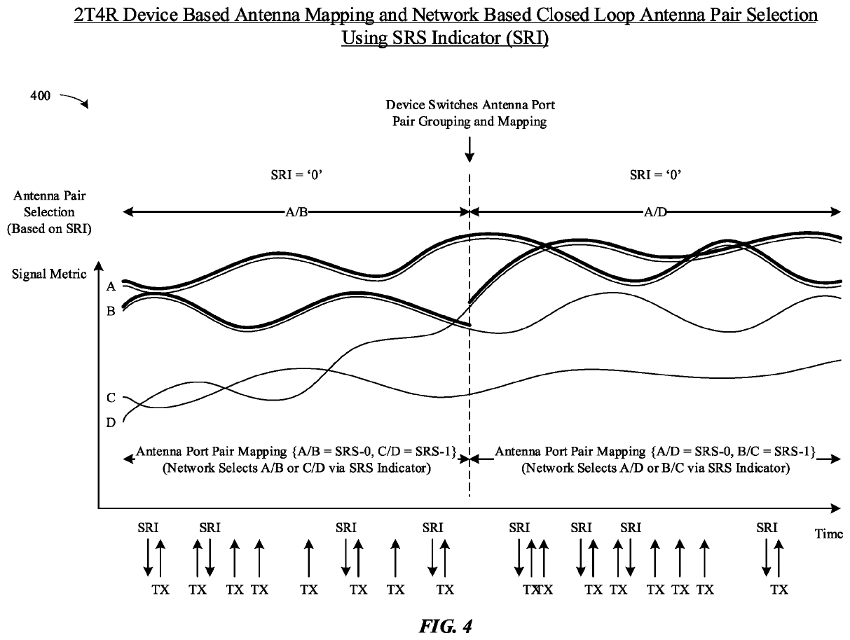

FIG. 3 illustrates tables 300, 310, 320 of examples of mapping SRS resources of an SRS resource set designated for codebook usage to antenna ports of a 2T4R wireless device 102. Prior art methods for antenna port mapping can assign different antenna ports arbitrarily to different SRS resources; however, this arbitrary assignment may result in suboptimal performance. Instead, the wireless device 102 can measure downlink performance metrics, e.g., signal strength, such as reference signal received power (RSRP) values, and/or signal quality, such as signal-to-interference-plus-noise (SINR) values for each antenna port of the wireless device 102. The wireless device 102 can account for individual antenna port characteristics known to the wireless device 102, such as MTPL limitations for different bandwidth transmissions when using different RF bands, total isotropic sensitivity (TIS) values for receive chains of the antenna ports, and total radiated power (TRP) values for transmit chains of the antenna ports. The wireless device 102 can map sets of antenna ports to different SRS resources to achieve balanced and/or best performance for transmission and/or reception via individual antenna ports and/or combinations of antenna ports. For a 2T4R wireless device 102, with two UL transmit chains, the wireless device 102 can group the four antenna ports into antenna port groups of two antenna ports each, where each antenna port group can have comparable signal performance metrics. For example, the wireless device 102 can use the performance metrics to rank the individual antenna ports and subsequently map the antenna ports to SRS resources as shown in tables 300, 310, or 320. For table 300, the wireless device 102 groups the two best antenna ports together into a first antenna port group and maps the first antenna port group to a first SRS resource of an SRS resource set, e.g., to SRS-0. The wireless device 102 further groups the next two best (or in this case with only four antenna ports, the worst two) antenna ports together into a second antenna port group and maps the second antenna port group to a second SRS resource of the SRS resource set, e.g., to SRS-1. Alternatively, as shown for table 310, the wireless device 102 can map the first antenna port group to the second SRS resource of the SRS resource set, e.g., to SRS-1, and map the second antenna port group to the first SRS resource of the SRS resource set, e.g., to SRS-0. The wireless device 102 can transmit the SRS resources via each antenna group separately as described for FIG. 1E, and the base station can select an antenna group and a precoding matrix for the wireless device to subsequently use for UL physical layer channel transmissions, e.g., for PUSCH transmissions. The base station can indicate the selected antenna group using an SRI value, that indicates the SRS resource associated with the selected antenna group. The base station can further select an individual antenna within the selected antenna group by indicating a particular non-coherent precoding matrix by indicating a particular TPMI value.

In an alternative configuration, the wireless device 102 groups the best two antennas into an antenna group and maps the antenna group to a single SRS resource, SRS-0, of an SRS resource set configured to the wireless device 102 with a codebook usage designation, where the SRS resource set only includes SRS-0, as shown in table 320. The wireless device 102 and transmits the SRS resource, SRS-0, via the antenna group to the base station, which determines an UL transmit precoder for the wireless device 102 and indicates the determined UL transmit precoder by sending a TPMI value to the wireless device 102 in a DCI message. This alternative arrangement summarized in table 320 corresponds to the UL sounding scheme illustrated in FIG. 1F. The wireless device 102 can change the grouping and mapping of antennas based on DL performance metric monitoring. The base station can be unaware of the change in antenna grouping and/or mapping of the antenna group to the SRS resource by the wireless device 102, although changes in UL performance and selection of the precoder based on the transmitted two-port SRS resource via the antenna group still occurs.

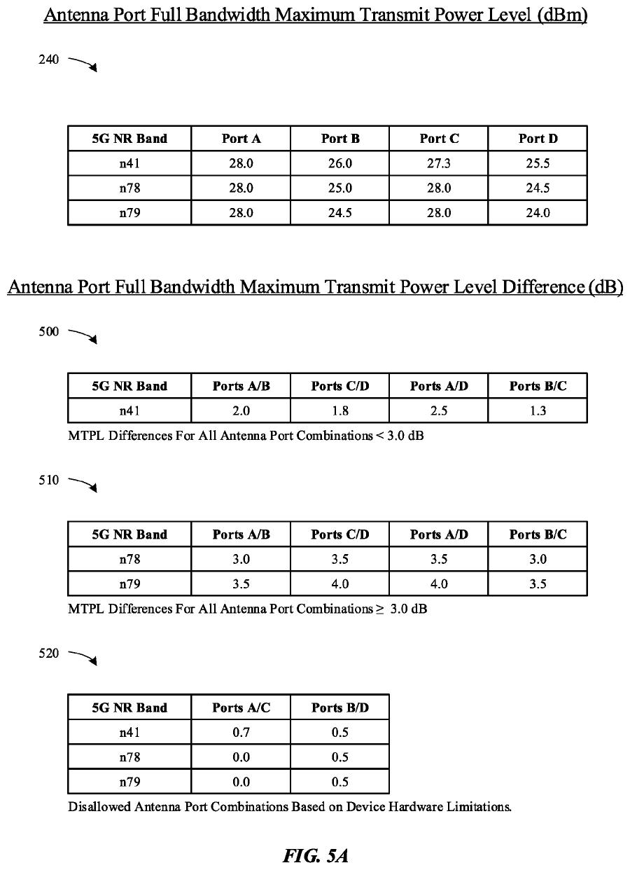

FIG. 4 illustrates a diagram 400 of an example of device-based antenna grouping and mapping and network-based closed-loop antenna group (pair) selection for a 2T4R wireless device 102. The wireless device 102 monitors DL performance metrics for four antenna ports, pairs the antenna ports together into antenna port pairs, and maps the antenna port pairs to SRS resources of an SRS resource set configured to the wireless device 102 with a codebook usage designation. As shown in FIG. 4, initially antenna ports A and B are grouped together, mapped to SRS-0, and have higher performance metrics than antenna ports C and D, which are also grouped together, and mapped to SRS-1. The wireless device 102 transmits the SRS resources SRS-0 and SRS-1 of the SRS resource set to the base station via the assigned (mapped) antenna port pairs A/B and C/D respectively. The base station measures the received SRS resources and selects either antenna port pair A/B or C/D for UL transmission. The base station indicates the selected antenna port pair to the wireless device 102 using an SRI value in a DCI message, e.g., SRI=‘0’ to select antenna port pair A/B associated with SRS-0. The wireless device 102 subsequently sends an UL physical layer channel transmission, e.g., a PUSCH transmission, via the selected antenna port pair A/B. The wireless device 102 can continue to use the selected antenna port pair A/B and change which antenna port pair is used based on a subsequent SRI received from the base station. The wireless device 102 can continue to monitor downlink performance via the multiple antenna ports and change the grouping of antenna ports to antenna port pairs and the mapping of antenna port pairs to SRS resources. The time interval between successive changes in antenna port grouping and mapping can be substantially longer than the time interval between successive SRS transmissions and SRI responses. As shown in FIG. 4, the wireless device 102 regroups the antenna ports based on measured DL performance metrics into new antenna port pairs, where antenna ports A and D are grouped together and mapped to SRS-0, while antenna ports B and C are grouped together and mapped to SRS-1. The wireless device 102 transmits the SRS resources SRS-0 and SRS-1 of the SRS resource set to the base station via the assigned (mapped) antenna port pairs A/D and B/C respectively. The base station measures the receives SRS resources and selects either antenna port pair A/D or B/C for UL transmission. The base station indicates the selected antenna port pair to the wireless device 102 using an SRI value in a DC message, e.g., SRI=‘0’ to select antenna port pair A/D associated with SRS-0. The wireless device 102 subsequently sends an UL physical layer channel transmission, e.g., a PUSCH transmission, via the selected antenna port pair A/D.

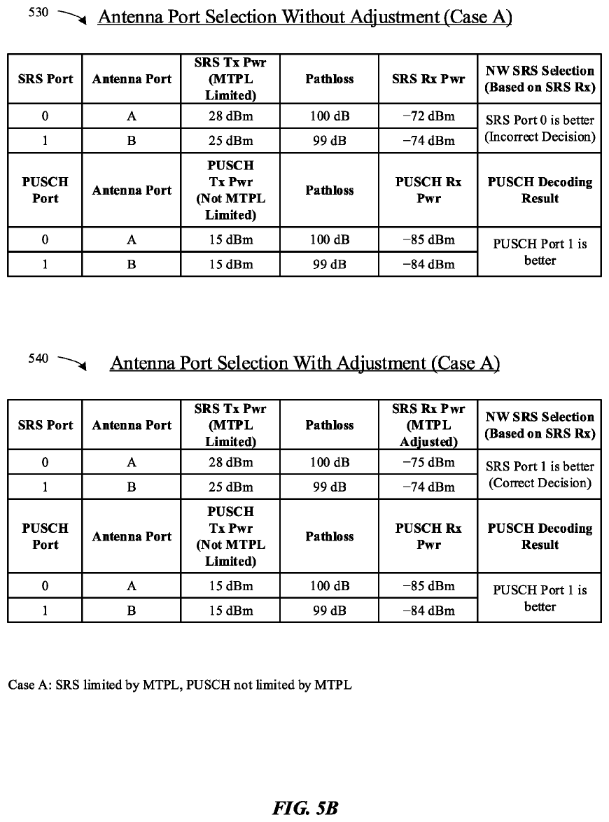

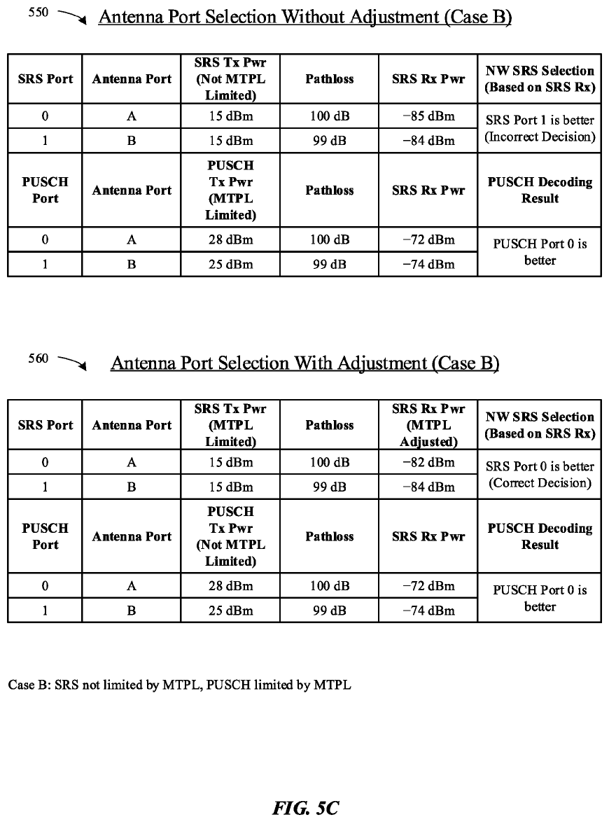

In some cases, e.g., due to hardware limitations of a wireless device 102, only certain antenna port groupings can be used for UL MIMO transmission. The wireless device 102 can be restricted to use only particular antenna port groupings when grouping (e.g., pairing) together different antenna ports into an antenna port group to map to an SRS resource. As discussed herein, different antenna ports can have different MTPL values for full (or wide) bandwidth transmission, an example of which is summarized in table 240 of FIG. 2D and reshown in FIG. 5A for clarity. Grouping antenna ports together into an antenna port group can result in antenna ports having different MTPL values in the same antenna port group. FIG. 5A illustrates tables 500, 510, 520 of examples of MTPL difference values for pairs of antenna ports of a 2T4R wireless device 102 when transmitting in different 5GNR radio frequency bands, where the antenna ports of the wireless device 102 have the MTPL values shown in table 240. For a 2T4R wireless device 102, exemplary allowed antenna port groupings include antenna port pairs A/B, C/D, A/D, and B/C, while exemplary disallowed antenna port groupings, e.g., due to hardware limitations of the 2T4R wireless device 102, include antenna port pairs A/C and B/D. The MTPL difference values for different antenna port pairs can vary based on the 5G NR band used for UL transmission. For the n41 band, which is a time-division duplexing (TDD) band at 2.5 GHz, all combinations of antenna port pairings have an MTPL difference of less than 3 dB as shown in table 500. For the n78 and n79 bands, which are TDD bands at 3.5 and 4.7 GHz respectively, all combinations of antenna port pairs have an MTPL difference of at least 3 dB as shown in table 510. Table 520 summarizes the MTPL differences for disallowed antenna pair combinations that cannot be used by the wireless device 102.

The base station, which measures performance of the antenna port groups, can be unaware of the MTPL differences between the antenna ports of each antenna port group. To overcome this limitation, in some embodiments, the wireless device 102 maps a strongest antenna port within each antenna port group to a particular SRS port within an SRS resource, e.g., to an SRS resource having a lowest index value (or alternatively a highest index value). The wireless device 102 can signal to the base station the mapping of the strongest antenna ports by reporting a particular TPMI Group value. In some embodiments, the wireless device 102 reports a full power mode2 capability to the base station and provides a two ports TPMI group value of ‘01’ to indicate that the strongest antenna port of each antenna port group is mapped to the first SRS port, e.g., SRS-0, of the SRS resource associated with the antenna port group. Alternatively, the wireless device 102 can report a full power mode2 capability to the base station and provide a TPMI group value of ‘10’ to indicate that the strongest antenna port of each antenna port group is mapped to the second SRS port, e.g., SRS-1, of the SRS resource associated with the antenna port group. The wireless device 102 can selectively send a two ports TPMI group value when the MTPL differences between antenna ports of all antenna port groups (pairs) satisfy an MTPL difference threshold, e.g., at least 3 dB, and the wireless device 102 can refrain from sending the two ports TPMI group value when the MTPL differences between antenna ports of all antenna port groups (pairs) do not satisfy the MTPL difference threshold, e.g., at least one antenna port pair has an MTPL different of less than 3 dB. For the n41 band shown in table 500, the wireless device 102 does not report the two ports TPMI group value, as the MTPL differences between antenna ports of the antenna port groups do not meet the MTPL difference threshold (e.g., 3 dB). For the n78 and n79 bands shown in table 510, the wireless device 102 does report a two ports TPMI group value, as the MPTL differences between antenna ports of the antenna groups all meet the MTPL different threshold (e.g., 3 dB). The base station can recognize the reported full power mode2 capability and reported TPMI group value to learn that indicated antenna ports (at a particular position within antenna port groups) have higher performance (e.g., higher MTPL values) and can account for this difference in MPTL values between antenna ports when determining an antenna port group selection and/or when determining an antenna port selection within an antenna port group.

In some embodiments, the base station estimates whether SRS transmissions or PUSCH transmissions are MTPL limited for individual antenna ports of an antenna port group (pair) and compensates for an MTPL limitation (of either SRS or PUSCH transmissions) when determining antenna port selection. FIG. 5B illustrates tables 530, 540 of examples of antenna port selection with and without adjustments being applied based on MTPL limitations for a first representative example (case A) in which SRS transmissions by the wireless device 102 are limited by MTPL, while PUSCH transmissions by the wireless device 102 are not limited by MTPL. In table 530, the base station does not adjust antenna selection for MTPL limitations. The wireless device 102 is configured with an SRS resource set including an SRS resource having two SRS ports 0 and 1 mapped to individual antenna ports A and B. Transmission of the SRS resource by the wireless device 102 is limited to 28 dBm via antenna port A and to 25 dBm via antenna port B. In the example of table 530, actual pathloss attenuation for transmission via antenna ports A and B are 100 and 99 dB respectively, resulting in a received SRS resource measurement of −72 dBm for antenna port A and −74 dBm for antenna port B. In the example of table 530, the base station does not recognize the MTPL limitation that impacted the received SRS resource measurements and can determine that antenna port A (associated with SRS port 0) has better performance and select antenna port A for a subsequent PUSCH transmission. When transmitting the PUSCH, however, the wireless device 102 is not limited by the MTPL of the antenna ports, as the PUSCH transmit power level is only 15 dBm via each antenna port, resulting in a receive PUSCH power level of −85 dBm for antenna port A and −84 dBm for antenna port B. In this case the UL performance for the PUSCH via antenna port B is better that for antenna port A, and the base station can make an incorrect decision for PUSCH transmission based on using the SRS measurements without compensating for MTPL differences of antenna ports. In table 540, the base station does account for MTPL limitations when selecting antenna ports. The base station determines that the SRS is limited by MTPL for SRS port 0 (corresponding to antenna port A) and adjusts the received SRS power level for SRS port 0 downward by subtracting an adjustment factor (e.g., 3 dB) to the measured received SRS power level. With this adjustment, the base station can select and indicate SRS port 1 corresponding to antenna port B, which can provide a higher level of performance for the subsequent PUSCH transmission than antenna port A. With the adjustment, the base station makes a correct decision for PUSCH transmission by accounting for MTPL differences of the antenna ports.

FIG. 5C illustrates tables 550, 560 of examples of antenna port selection with and without adjustment based on MTPL limitations for a second representative example (case B) in which SRS transmissions by the wireless device 102 are not limited by MTPL, while PUSCH transmissions by the wireless device 102 are limited by MTPL. In table 550, the base station does not account for MTPL limitations when determining antenna selection. The wireless device 102 is configured with an SRS resource set including an SRS resource having two SRS ports 0 and 1 mapped to individual antenna ports A and B. Transmission of the SRS resource by the wireless device 102 is at 15 dBm via antenna port A and 15 dBm via antenna port B. The SRS transmission of case B can use a narrower bandwidth (and therefore less total power) than the SRS transmission of case A. In the example of table 550, actual pathloss attenuation for transmission via antenna ports A and B are 100 and 99 dB respectively, resulting in a received SRS resource measured at −85 dBm for antenna port A and −84 dBm for antenna port B. In the example of table 550, the base station does not recognize that the subsequent PUSCH transmission will have an MTPL limitation and can determine that antenna port B (associated with SRS port 1) has better performance and select antenna port B for the subsequent PUSCH transmission. When transmitting the PUSCH, however, the wireless device 102 is limited by the MTPL of the antenna ports, as the PUSCH transmit power level is limited to 28 dBm via antenna port A and 25 dBm via antenna port B, resulting in a receive PUSCH power level of −72 dBm for antenna port A and −74 dBm for antenna port B. In this case the UL performance for the PUSCH via antenna port A is better that for antenna port B, and the base station can make an incorrect decision for PUSCH transmission based on using the previously received SRS measurements without compensating for MTPL differences of antenna ports for the subsequent PUSCH transmission. In table 560, the base station does account for MTPL limitations when selecting antenna ports. The base station determines that the PUSCH is limited by MTPL for SRS port 0 (corresponding to antenna port A) and adjusts the received SRS power level for SRS port 0 upward by adding an adjustment factor (e.g., 3 dB) to the measured received SRS power level. With this adjustment, the base station can select and indicate SRS port 0 corresponding to antenna port A, which can provide a higher level of performance for the subsequent PUSCH transmission than antenna port B. With the adjustment, the base station makes a correct decision for PUSCH transmission by accounting for MTPL differences of the antenna ports.

The base station can determine whether a PUSCH transmission of the wireless device 102 is MTPL limited based on a power headroom report (PHR) provided by the wireless device 102. The base station can also determine whether an SRS transmission of the wireless device 102 is MTPL limited using a power headroom (PH) value include in the PHR and knowledge of bandwidths used for the PUSCH and SRS transmissions respectively. The PHR can provide a PH value for the PUSCH, and the wireless device 102 can scale the PH value for the PUSCH to derive a corresponding PH value for the SRS based on a ratio of bandwidth used for the PUSCH transmission and a bandwidth used for the SRS transmission.

In some embodiments, the wireless device 102 supports coherent UL MIMO transmission, in which case grouping antenna ports together based on individual antenna port performance, as used for the non-coherent UL MIMO cases, may not provide an optimal solution. The wireless device 102 instead can determine best antenna port combinations based on performance metrics for individual antenna ports and a channel correlation between UL channels via the different antenna ports of antenna port combinations. The wireless device can determine allowable antenna port groupings. For a 2T4R wireless device 102 for example, allowable antenna port groups can include antenna port combinations of {A, B}, {C, D}, {A, D}, and {B, C}. The wireless device 102 can then select an antenna port group to map to a first codebook SRS resource based on an estimate of channel capacities for each of the antenna port combinations. The wireless device 102 can monitor downlink performance metrics, such as signal strength, e.g., reference signal received power (RSRP) values, and signal quality, e.g., signal-to-interference-plus-noise (SINR) values for each antenna port. The wireless device 102 can further measure (or obtain from a base station) channel information estimates for each antenna port. The channel information estimate for an antenna port ‘x’ can be denoted as H_{port_x}. The wireless device 102 can determine a scaling factor, denoted as Scaling_{port_x}, for each antenna port based on a linear combination of an SINR value for the antenna port, SINR_{port_x}, an MTPL value for the antenna port, MTPL_{port_x} a TIS value for the antenna port, TIS_{port_x}, and a TRP value for the antenna port, TRP_{port_x}.

$${Scaling}_{port \_ x} = linear ( {SINR}_{port \_ x} + M T P {L}_{port \_ x} + {TIS}_{port \_ x} - T R {P}_{port \_ x} )$$

The wireless device 102 can apply the scaling factors for each antenna port to the channel information estimate for the respective antenna port to derive a scaled channel information estimate for each antenna port.

$${\hat{H}}_{port \_ x} = {Scaling}_{port \_ x} \times {H}_{port \_ x}$$

The wireless device 102 can derive a mutual correlation channel information matrix R_{<x,y>} between two antenna ports x and y as follows, where ( )^{H} indicates a Hermitian transform.

$${\hat{H}}_{〈 x , y 〉} = [ \begin{matrix}{\hat{H}}_{port \_ x} \\ {\hat{H}}_{port \_ y}\end{matrix} ]$$

$${R}_{〈 x , y 〉} = {( {\hat{H}}_{〈 x , y 〉} )}^{H} \cdot {\hat{H}}_{〈 x , y 〉}$$

The wireless device 102 can determine a mutual information channel capacity of the antenna port combination of antenna ports x and y based on eigenvalues of the mutual correlation channel information matrix R_{<x,y>}. The wireless device 102 can select a best antenna port combination (e.g., a best antenna port pair) with a highest mutual information channel capacity and map two SRS ports of a first codebook SRS resource to the selected best antenna port combination (pair).

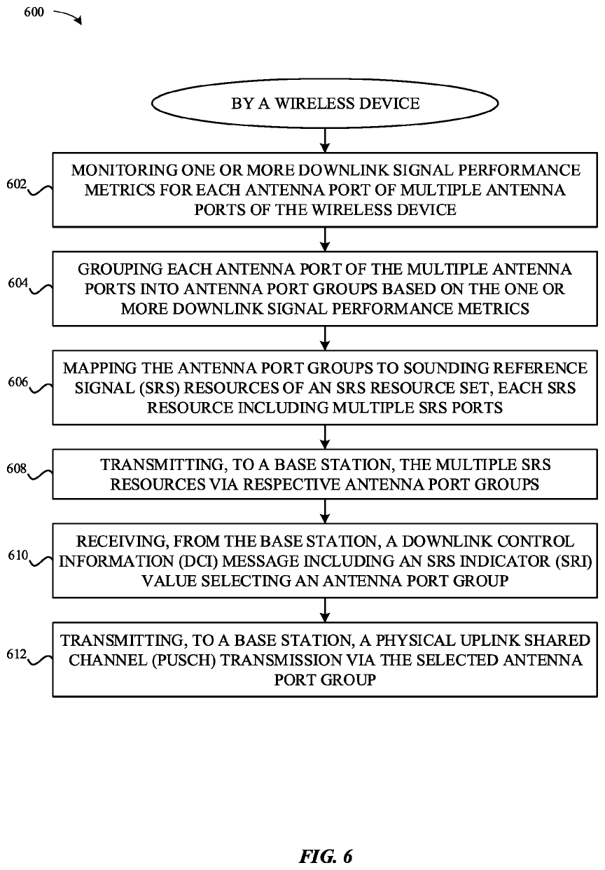

FIG. 6 illustrates a flowchart 600 of an exemplary method for UL transmit antenna selection for a wireless device 102. At 602, the wireless device 102 monitors one or more downlink signal performance metrics for each antenna port of multiple antenna ports of the wireless device 102. At 604, the wireless device 102 groups each antenna port of the multiple antenna ports into antenna port groups based on the one or more downlink signal performance metrics. At 606, the wireless device 102 maps the antenna port groups to sounding reference signal (SRS) resources of an SRS resource set, where each SRS resource includes multiple SRS ports. At 608, the wireless device 102 transmits, to a base station of a cellular wireless network, the multiple SRS resources via the corresponding respective antenna port groups. At 610, the wireless device 102, receives, from the base station, a downlink control information (DCI) message that includes an SRS indicator (SRI) value that selects a particular antenna port group. At 612, the wireless device 102 transmits, to the base station, a PUSCH transmission via the selected antenna port group.

In some embodiments, the wireless device 102 groups each antenna port of the multiple antenna ports together into antenna port groups based on the grouped antenna ports having comparable downlink signal performance metrics. In some embodiments, the wireless device maps the antenna port groups to the SRS resources by at least: i) mapping a first antenna port group having highest valued downlink signal performance metrics to a first SRS resource, and ii) mapping a second antenna port group having second-highest valued downlink signal performance metrics to a second SRS resource. In some embodiments, the first SRS resource corresponds to an SRS resource identifier value of zero. In some embodiments, the first SRS resource corresponds to an SRS resource identifier value of one. In some embodiments, the method for UL transmit selection performed by the wireless device 102 further includes the wireless device 102: i) continuing to monitor the one or more downlink signal performance metrics for each antenna port of the multiple antenna ports, ii) re-grouping each antenna port of the multiple antenna ports into new antenna port groups based on one or more updated downlink signal performance metrics, iii) re-mapping the new antenna port groups to the multiple SRS resources, and iv) transmitting, to the base station, the multiple SRS resources via respective re-mapped antenna port groups. In some embodiments, re-grouping the multiple antenna ports includes pairing at least one antenna port with a different antenna port from a previously paired antenna port in an antenna port group. In some embodiments, the one or more downlink signal performance metrics for each antenna port include one or more of a reference signal received power (RSRP), a reference signal received quality (RSRQ), or a signal-to-interference-plus-noise (SINR) for the respective antenna port. In some embodiments, the DCI message further includes a transmit precoding matrix indicator (TPMI) value indicating a precoder for the wireless device 102 to use when transmitting the PUSCH transmission to the wireless network. In some embodiments, the wireless device 102 is configured for non-coherent uplink multiple-input multiple-output (MIMO) rank one transmission, and the TPMI value selects a single antenna port of the antenna port group selected for PUSCH transmission.

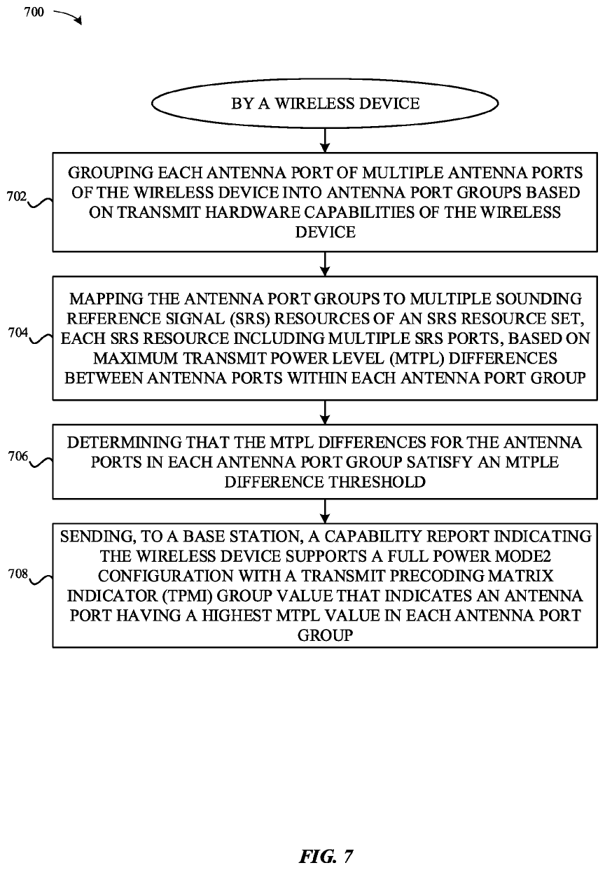

FIG. 7 illustrates a flowchart 700 of another exemplary method for UL transmit antenna selection for a wireless device 102. At 702, the wireless device 102 groups each antenna port of multiple antenna ports of the wireless device 102 into antenna port groups based on transmit hardware capabilities of the wireless device 102. At 704, the wireless device 102 maps the antenna port groups to multiple SRS resources of an SRS resource set, where each SRS resource includes multiple SRS ports, based on differences of maximum transmit power level (MTPL) values for the antenna ports within each antenna port group. At 706, the wireless device 102 determines that the MPTL differences for the antenna ports within each antenna port group satisfy an MTPL difference threshold. At 708, the wireless device sends, to a base station, a capability report indicating the wireless device 102 supports a full power mode2 configuration with a transmit precoding matrix indicator (TPMI) group value that indicates an antenna port having a highest MTPL value in each antenna port group.

In some embodiments, the wireless device 102 maps the antenna ports to the multiple SRS resources by at least mapping, in each antenna port group, an antenna port having a highest MTPL value to an SRS resource having a lowest identifier value in a corresponding SRS resource set. In some embodiments, the wireless device 102 supports a 2T4R configuration and reports a TPMI group value of ‘01’ or ‘10’ for a two ports configuration to the base station of the cellular wireless network depending on which antenna ports have the highest MTPL values. In some embodiments, the wireless device supports a 4T4R configuration and reports a TPMI group value of ‘G0’, ‘G1’, ‘G2’, or ‘G3’ for a four ports configuration to the base station of the cellular wireless network depending on which antenna ports have the highest MTPL values. In some embodiments, the method for UL transmit antenna selection further includes the wireless device 102: i) transmitting, to the base station, the multiple SRS resources via respective antenna ports, ii) receiving, from the base station, a downlink control information (DCI) message including an SRS indicator (SRI) value selecting an antenna port group, and iii) transmitting, to the base station, a physical uplink shared channel (PUSCH) transmission via the selected antenna port group.

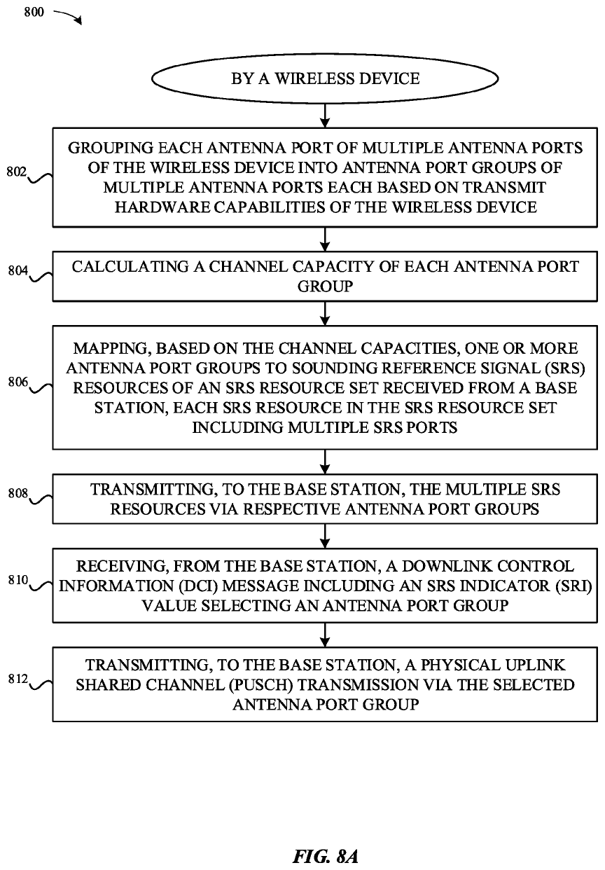

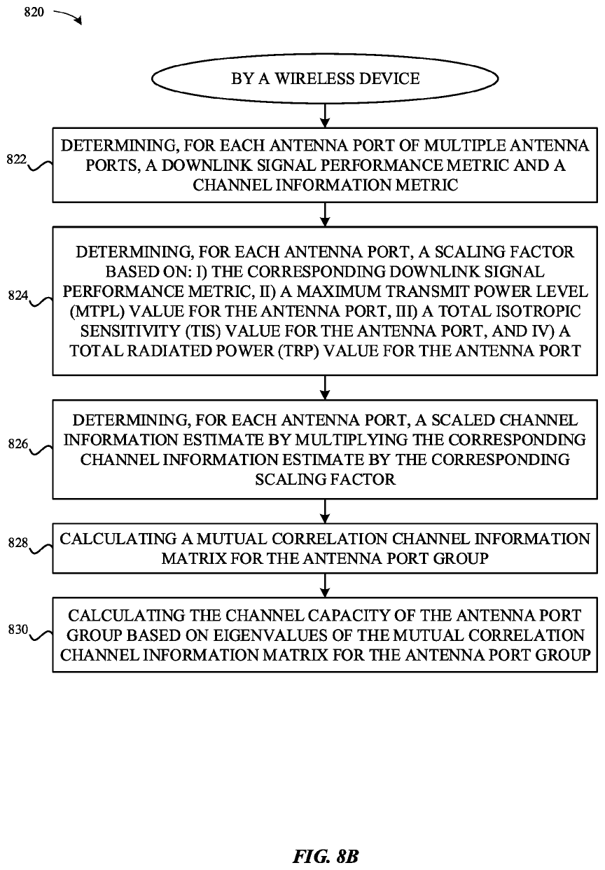

FIG. 8A illustrates a flowchart 800 of a further exemplary method for UL transmit antenna selection for a wireless device 102. At 802, the wireless device 102 groups each antenna port of multiple antenna ports of the wireless device 102 into antenna port groups of multiple antenna ports each based on transmit hardware capabilities of the wireless device 102. At 804, the wireless device 102 calculates a channel capacity of each antenna port group. At 806, the wireless device 102 maps, based on the channel capacities, one or more antenna port groups to sounding reference signal (SRS) resources of an SRS resource set received from the base station, each SRS resource in the SRS resource set including multiple SRS ports. At 808, the wireless device 102 transmits, to the base station, the multiple SRS resources via respective antenna port groups. At 810, the wireless device 102 receives, from the base station, a DCI message including an SRI value selecting an antenna port group. At 812, the wireless device 102 transmits, to the base station, a PUSCH transmission via the selected antenna port group.

FIG. 8B illustrates a flowchart 820 for calculating the channel capacity of an antenna port group of a wireless device 102. At 822, the wireless device 102 determines, for each antenna port of multiple antenna ports of the wireless device 102, a downlink signal performance metric and a channel information estimate. At 824, the wireless device 102 determines, for each antenna port a scaling factor based on: i) the corresponding downlink signal performance metric, ii) a maximum transmit power level (MTPL) value for the antenna port, iii) a total isotropic sensitivity (TIS) value for the antenna port, and iv) a total radiated power (TRP) value for the antenna port. At 826, the wireless device 102 determines, for each antenna port, a scaled channel information estimate by multiplying the corresponding channel information estimate by the corresponding scaling factor. At 828, the wireless device 102 calculates a mutual correlation channel information matrix for one or more antenna port groups formed by grouping together antenna ports by the wireless device 102, such as based on allowable antenna port combinations. At 830, the wireless device 102 calculates the channel capacity of an antenna port group based on eigenvalues of the mutual correlation channel information matrix for the corresponding antenna port group. In some embodiments, the number of antenna port groups exceeds the number of SRS resources in the SRS resource set, and the wireless device 102 maps the one or more antenna port groups to the SRS resources by at least associating antenna port groups to SRS resources starting with a highest channel capacity antenna port group and continuing in descending order of calculated channel capacities of the antenna port groups.

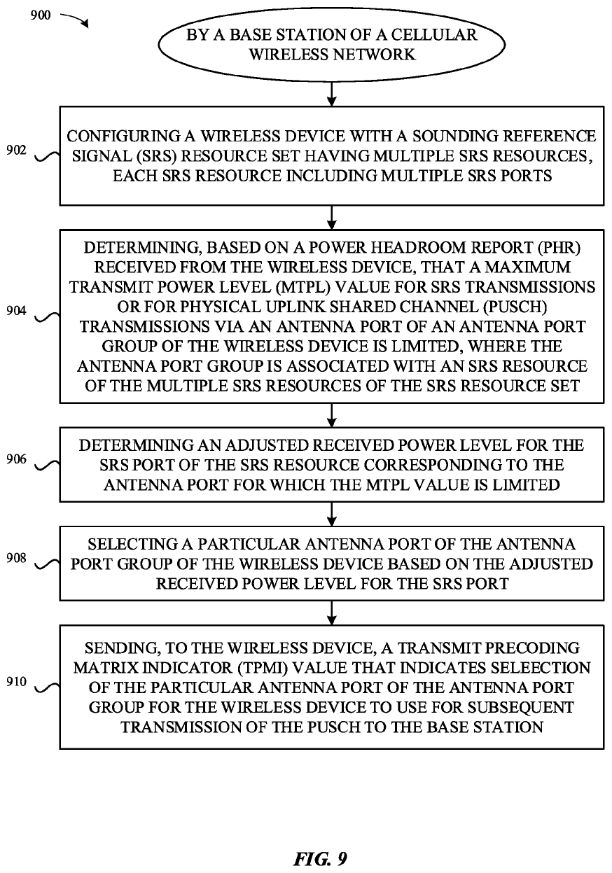

FIG. 9 illustrates a flowchart 900 of a method for UL transmit antenna selection for a wireless device 102 performed by a base station, e.g., gNodeB 112, of a cellular wireless network. At 902, the base station configures the wireless device 102 with an SRS resource set that has multiple SRS resources, each SRS resource including multiple SRS ports. At 904, the base station determines, based on a power headroom report (PHR) from the wireless device 102, that an MTPL value for SRS transmission or for PUSCH transmissions via an antenna port of an antenna port group of the wireless device 102 is limited, where the antenna port group is associated with an SRS resource of the multiple SRS resources of the SRS resource set. At 906, the base station determines an adjusted received power level for the SRS port of the SRS resource corresponding to the antenna port for which the MTPL value is limited. At 908, the base station selects a particular antenna port of the antenna port group of the wireless device 102 based on the adjusted received power level for the SRS port. At 910, the base station sends to the wireless device 102 a TPMI value that indicates selection of the particular antenna port of the antenna port group for the wireless device 102 to use for subsequent transmission of the PUSCH to the base station.

In some embodiments, the base station determines the adjusted received power level for the SRS port of the SRS resource by at least increasing the received power level for the SRS port by an adjustment value when PUSCH transmissions are MTPL limited via the antenna port and the SRS transmissions are not MTPL limited via the antenna port. In some embodiments, the base station determines that the MTPL value for PUSCH transmissions via the antenna port is limited is based on a power headroom value included in the PHR received from the wireless device 102. In some embodiments, the base station determines the adjusted received power level for the SRS port of the SRS resource by at least decreasing the received power level for the SRS port by an adjustment value when SRS transmissions are MTPL limited via the antenna port and the PUSCH transmissions are not MTPL limited via the antenna port. In some embodiments, the base station determines that the MTPL value for SRS transmissions via the antenna port is limited by at least: i) calculating a ratio of a first transmission bandwidth used for the PUSCH transmissions to a second transmission bandwidth used for the SRS transmissions, ii) applying the ratio to a reported power headroom value included in the PHR received from the wireless device to derive a scaled power headroom value, and iii) determining whether the MTPL for SRS transmissions is limited based on the scaled power headroom value.

### Representative Exemplary Apparatus

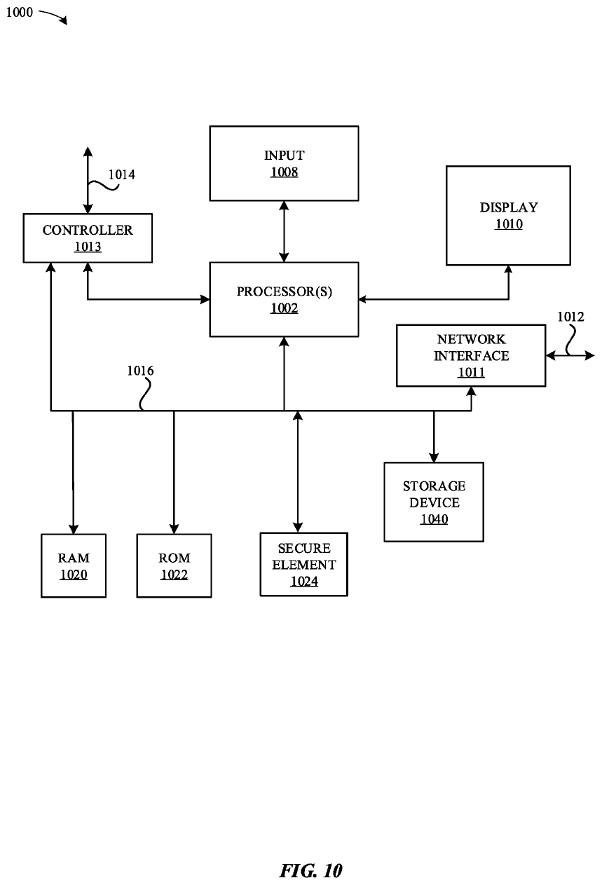

FIG. 10 illustrates in block diagram format an exemplary computing device 1000 that can be used to implement the various components and techniques described herein, according to some embodiments. In particular, the detailed view of the exemplary computing device 1000 illustrates various components that can be included in a wireless device, e.g., wireless device 102. As shown in FIG. 10, the computing device 100 can include one or more processors 1002 that represent microprocessors or controllers for controlling the overall operation of computing device 1000. In some embodiments, the computing device 1000 can also include a user input device 1008 that allows a user of the computing device 1000 to interact with the computing device 1000. For example, in some embodiments, the user input device 1008 can take a variety of forms, such as a button, keypad, dial, touch screen, audio input interface, visual/image capture input interface, input in the form of sensor data, etc. In some embodiments, the computing device 1000 can include a display 1010 (screen display) that can be controlled by the processor(s) 1002 to display information to the user (for example, information relating to incoming, outgoing, or active communication sessions). A data bus 1016 can facilitate data transfer between at least a storage device 1040, the processor(s) 1002, and a controller 1013. The controller 1013 can be used to interface with and control different equipment through an equipment control bus 1014. The computing device 1000 can also include a network/bus interface 1011 that couples to a data link 1012. In the case of a wireless connection, the network/bus interface 1011 can include wireless circuitry, such as a wireless transceiver and/or baseband processor. The computing device 1000 can also include a secure element 1024. The secure element 1024 can include an eUICC.

The computing device 1000 also includes a storage device 1040, which can include a single storage or a plurality of storages (e.g., hard drives), and includes a storage management module that manages one or more partitions within the storage device 1040. In some embodiments, storage device 1040 can include flash memory, semiconductor (solid state) memory or the like. The computing device 1000 can also include a Random-Access Memory (RAM) 1020 and a Read-Only Memory (ROM) 1022. The ROM 1022 can store programs, utilities or processes to be executed in a non-volatile manner. The RAM 1020 can provide volatile data storage, and stores instructions related to the operation of the computing device 1000.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for uplink (UL) transmit antenna selection for a wireless device communicating with a base station of a cellular wireless network, the method comprising:
monitoring one or more downlink signal performance metrics for each antenna port of a plurality of antenna ports;
grouping the each antenna port of the plurality of antenna ports into antenna port groups based on the one or more downlink signal performance metrics;
mapping the antenna port groups to a plurality of sounding reference signal (SRS) resources of an SRS resource set, each SRS resource comprising a plurality of SRS ports;
transmitting, to the base station, the plurality of SRS resources via respective antenna port groups;
receiving, from the base station, a downlink control information (DCI) message including an SRS indicator (SRI) value selecting an antenna port group; and
transmitting, to the base station, a physical uplink shared channel (PUSCH) transmission via the selected antenna port group.

2. The method of claim 1, wherein:
the each antenna port of the plurality of antenna ports is grouped together into the antenna port groups based on having comparable downlink signal performance metrics.

3. The method of claim 1, wherein:
mapping the antenna port groups to the plurality of SRS resources includes:
mapping a first antenna port group having highest valued downlink signal performance metrics to a first SRS resource; and
mapping a second antenna port group having second-highest valued downlink signal performance metrics to a second SRS resource.

4. The method of claim 3, wherein the first SRS resource corresponds to an SRS resource identifier value of zero.

5. The method of claim 3, wherein the first SRS resource corresponds to an SRS resource identifier value of one.

6. The method of claim 1, further comprising:
continuing to monitor the one or more downlink signal performance metrics for each antenna port of the plurality of antenna ports;
re-grouping the each antenna port of the plurality of antenna ports into new antenna port groups based on one or more updated downlink signal performance metrics;
re-mapping the new antenna port groups to the plurality of SRS resources; and
transmitting, to the base station, the plurality of SRS resources via respective re-mapped antenna port groups.

7. The method of claim 1, wherein re-grouping the plurality of antenna ports comprises pairing at least one antenna port with a different antenna port from a previously paired antenna port.

8. The method of claim 1, wherein the one or more downlink signal performance metrics for each antenna port comprise one or more of: a reference signal received power (RSRP), a reference signal received quality (RSRQ), or a signal-to-interference-plus-noise (SINR) for the respective antenna port.

9. The method of claim 1, wherein the DCI message further includes a transmit precoding matrix indicator (TPMI) value indicating a precoder for the wireless device to use when transmitting the PUSCH transmission to the cellular wireless network.

10. The method of claim 9, wherein:
the TPMI value selects a single antenna port of the antenna port group selected for PUSCH transmission, while configured for non-coherent uplink multiple-input multiple-output (MIMO) rank one transmission.

11. A method for uplink (UL) transmit antenna selection for a wireless device communicating with a base station of a cellular wireless network, the method comprising:
grouping each antenna port of a plurality of antenna ports of the wireless device into antenna port groups based on transmit hardware capabilities of the wireless device;
mapping the antenna port groups to a plurality of sounding reference signal (SRS) resources of an SRS resource set, each SRS resource comprising a plurality of SRS ports, based on maximum transmit power level (MTPL) differences between antenna ports within each antenna port group;
determining that the MTPL differences for the antenna ports in each antenna port group satisfy an MTPL difference threshold; and
sending, to the base station, a capability report indicating the wireless device supports a full power mode2 configuration with a transmit precoding matrix indicator (TPMI) group value that indicates an antenna port having a highest MTPL value in each antenna port group.

12. The method of claim 11, wherein mapping the antennas ports to the plurality of SRS resources comprises:
mapping, in each antenna port group, an antenna port having a highest MTPL value to an SRS resource having a lowest identifier value in a corresponding SRS resource set.

13. The method of claim 12, wherein:
reporting a TPMI group value of ‘01’ or ‘10’ for a two ports configuration to the base station of the cellular wireless network depending on which antenna ports have the highest MTPL values, wherein the wireless device supports a 2T4R configuration.

14. The method of claim 12, wherein:
reporting a TPMI group value of ‘G0’, ‘G1’, ‘G2’, or ‘G3’ for a four ports configuration to the base station of the cellular wireless network depending on which antenna ports have the highest MTPL values, wherein the wireless device supports a 4T4R configuration.

15. The method of claim 11, further comprising:
transmitting, to the base station, the plurality of SRS resources via respective antenna ports;
receiving, from the base station, a downlink control information (DCI) message including an SRS indicator (SRI) value selecting an antenna port group; and
transmitting, to the base station, a physical uplink shared channel (PUSCH) transmission via the selected antenna port group.

16.-18. (canceled)

19. A method for uplink (UL) transmit antenna selection for a wireless device communicating with a base station of a cellular wireless network, the method comprising:
by the base station:
configuring the wireless device with a sounding reference signal (SRS) resource set having a plurality of SRS resources, each SRS resource comprising a plurality of SRS ports;
determining, based on a power headroom report (PHR) received from the wireless device, that a maximum transmit power level (MTPL) value for SRS transmissions or an MTPL value for physical uplink shared channel (PUSCH) transmissions via an antenna port of an antenna port group of the wireless device is limited, wherein the antenna port group is associated with an SRS resource of the plurality of SRS resources;
measuring received power levels for transmissions of the plurality of SRS ports of the SRS resource received from the wireless device;
determining an adjusted received power level for the SRS port of the SRS resource corresponding to the antenna port for which the MTPL value is limited;
selecting a particular antenna port of the antenna port group of the wireless device based on the adjusted received power level for the SRS port; and
sending, to the wireless device, a transmit precoding matrix indicator (TPMI) value that indicates selection of the particular antenna port of the antenna port group for the wireless device to use for subsequent transmission of the PUSCH to the base station.

20. The method of claim 19, wherein determining the adjusted received power level for the SRS port of the SRS resource comprises increasing the received power level for the SRS port by an adjustment value when PUSCH transmissions are MTPL limited via the antenna port and the SRS transmissions are not MTPL limited via the antenna port.

21. The method of claim 20, wherein determining that the MTPL value for PUSCH transmissions via the antenna port is limited is based on a power headroom value included in the PHR received from the wireless device.

22. The method of claim 19, wherein determining the adjusted received power level for the SRS port of the SRS resource comprises decreasing the received power level for the SRS port by an adjustment value when SRS transmissions are MTPL limited via the antenna port and the PUSCH transmissions are not MTPL limited via the antenna port.

23. The method of claim 22, wherein determining that the MTPL value for SRS transmissions via the antenna port is limited comprises:
calculating a ratio of a first transmission bandwidth used for the PUSCH transmissions to a second transmission bandwidth used for the SRS transmissions; and
applying the ratio to a reported power headroom value included in the PHR received from the wireless device to derive a scaled power headroom value; and
determining whether the MTPL for SRS transmissions is limited based on the scaled power headroom value.

24.-27. (canceled)
